(19) United States
(12) Patent Application Publication
(10) Pub. No.: US 2012/0317043 A1
(43) Pub. Date: Dec. 13, 2012

(54) Method and System for Facilitating Verification of Ownership Status of a Jewelry-Related Item

(76) Inventor: Steven K. Yeko, SR., Janesville, WI (US)

(21) Appl. No.: 13/589,761

(22) Filed: Aug. 20, 2012

Related U.S. Application Data
(63) Continuation of application No. 12/499,591, filed on Jul. 8, 2009, now abandoned.
Application No. 12/499,591 is a continuation-in-part of application No. 11/192,337, filed on Jul. 29, 2005, now abandoned.
Application No. 11/192,337 is a continuation-in-part of application No. 10/835,896, filed on Apr. 30, 2004, now Pat. No. 7,461,017.

(51) Int. Cl. G06Q 99/00

(52) U.S. Cl. 705/318

(57) ABSTRACT

A method and system for facilitating verification of ownership of a first jewelry-related item are disclosed. In at least some embodiments, the method includes receiving at a central terminal, from a mobile device via an internet-type communications medium, a certificate number associated with a first certificate corresponding to the first jewelry-related item, where the central terminal is at least one of operated and controlled by an entity that provides guarantees or warranties in relation to a plurality of certificates that respectively pertain to respective jewelry items, the plurality of certificates including the first certificate. The method additionally includes searching a database associated with the central terminal for ownership data pertaining to the first jewelry-related item, and sending the ownership data from the central terminal for receipt by the mobile device.

### CROSS-REFERENCE TO RELATED APPLICATIONS

The present application is a continuation-in-part of U.S. patent application Ser. No. 11/192,337 filed on Jul. 29, 2005, entitled “System And Method For Enabling Jewelry Certification At Local Jeweler Sites”, which is a continuation-in-part of U.S. patent application Ser. No. 10/835,896 filed on Apr. 30, 2004 having the same title, both of which are incorporated by reference herein, and claims the benefit of each of those applications.

### STATEMENT REGARDING FEDERALLY SPONSORED RESEARCH OR DEVELOPMENT

Not Applicable

### FIELD OF THE INVENTION

The present invention relates to the sale of jewelry and, more particularly, to systems and methods for verifying or authenticating ownership of jewelry items, such as mounted precious stones and watches.

### BACKGROUND OF THE INVENTION

The jewelry industry is a highly-competitive and rapidly changing industry. Due to the relative infrequency with which individual consumers purchase jewelry, due to the wide variations in jewelry types, characteristics and values, and due to the relative difficulty in determining some characteristics associated with jewelry, consumers have difficulty in estimating the quality and value of jewelry items and often find the jewelry purchasing process to be a difficult one that involves a fair amount of apprehensiveness.

Traditionally, consumers have relied upon trusted local jewelers to explain the intricacies of jewelry to them when the time came for purchasing jewelry, and have also relied upon those jewelers to provide fair estimations of the quality and value of jewelry items that are being purchased. Nevertheless, as relationships have become more impersonal in the modern economy, consumers over time have also grown accustomed to obtaining independent, third-patty verification of various characteristics of their jewelry as a supplement to simply relying upon the statements of their personal jewelers.

In the case of diamonds, for example, several organizations have emerged that are capable of evaluating a given diamond in terms of various diamond characteristics (e.g., cut, clarity, color and carats) and issuing a certificate regarding the diamond's “grade” based upon its characteristics. In some circumstances, the issued certificate also will include an appraisal of the diamond's replacement value or cost, based upon its grade and possibly other information as well. Among the prominent organizations existing for providing such third-party verification of diamonds are the Gemological Institute of America (GIA), the American Gem Society Laboratories (AGSL), the World Gemmological Laboratory and the European Gemmological Laboratory (EGL).

Obtaining verification of a piece of jewelry's quality/value in this manner is a fairly complicated and costly procedure. The costs of mailing a jewelry item to and from a third party evaluator, insuring the jewelry item during the process, and paying for the charges of the third-party evaluation can become large (e.g., the fees of the third-party evaluator can themselves be in the range of $40 to $100 per item). In the case of moderately-expensive to expensive jewelry, such as diamonds worth $5000 or more, this is a cost that many consumers and/or jewelry retailers are willing to bear. However, in the case of less expensive to inexpensive jewelry (e.g., jewelry worth under $5000), such costs are typically too excessive to justify the third party evaluation.

Nevertheless, consumers purchasing less expensive to inexpensive jewelry still often do (or would) desire to have some type of verification or confirmation of the quality/value of jewelry items that they purchase. Some of this has been driven by the emergence of the internet and related e-commerce relating to the sale of jewelry items. Companies such as Blue Nile, Inc. have emerged that allow consumers to purchase jewelry items via the internet without physically visiting a retail outlet or viewing, in person, the jewelry item being purchased before the purchase is made. To allay informational and other concerns that consumers might have about the merchandise being purchased, such internet-based jewelry retailers have offered consumers grading/appraisal certificates regarding the jewelry being purchased.

As this internet jewelry trade has become more established, the desire on the part of consumers for similar grading/appraisal information in other, non-internet jewelry retail venues has increased. Consequently, as department stores and chain stores have expanded their capability to sell jewelry, particularly jewelry in this less expensive to inexpensive category, they have attempted to meet this consumer desire by offering identification certificates for the jewelry being sold and also, in some circumstances, providing an indication of “replacement value” on the certificates.

While appearing to provide valuable information to consumers, these certificates provided by department stores and chain stores are sometimes of limited actual value. Grading of the jewelry as indicated on the certificates may sometimes be performed in an inconsistent or “hulk-quantity” manner with few governing standards. In particular, the grade provided for an individual item of jewelry may not be determined at the time of purchase based upon an evaluation of that specific jewelry item but rather may be based upon a typical or average grade determined a priori for a group of jewelry items of which the specific jewelry item is one example. Indications of “replacement value” also may be determined in a relatively inconsistent or “bulk-quantity” manner that does not necessarily reflect the particular piece of jewelry under consideration. Further, since the grade and replacement value information indicated on such certificates is determined by the individual department store(s) or chain store(s) themselves, it may not always be appropriate to presume that this information is independent and unbiased.

Despite these concerns associated with department and chain store-issued jewelry certificates, consumers nevertheless perceive these certificates to have value, often simply because of the large size and prominent market reputations of particular department stores and store chains. For this reason, independent jewelry stores are coming under increased competitive pressure from department stores and chain stores, particularly with respect to the sale of less-expensive to inexpensive jewelry. Further, consumers who might otherwise benefit from the expertise and individualized customer care offered by independent jewelers are sometimes forgoing these benefits, in order to obtain these perceived benefits associated with department and chain store-issued certificates.

As discussed, customers who buy jewelry items in non-traditional venues such as large department and chain stores can face difficulties in terms of verifying the authenticity of the jewelry items being purchased. Yet at least large department and chain stores, by virtue of their sizes and reputations, can offer some confidence to customers that the items being purchased are authentic (albeit of perhaps lower quality in some circumstances) that the retailers actually own or otherwise have the right to sell such items. Yet in today's market there are now many sellers of jewelry items, such as individuals or small/independent stores that are not jewelry stores, who cannot offer this confidence to customers. This is especially common where the seller of a jewelry item is not the original retailer of the jewelry item, but rather is a downstream reseller of the original retailer of the jewelry item.

When dealing with such sellers of jewelry items, buyers can face difficulties not only in terms of verifying the authenticity of the jewelry items being sold, but also in terms of verifying whether the sellers actually are bonafide owners of (or otherwise have appropriate authority to sell) the jewelry items. While physical paperwork can occasionally be made available to a prospective purchaser that at least to some extent will demonstrate that the prospective seller of a jewelry item does in fact have authority to do so (e.g., in the form of copies of receipts of previous sales of the jewelry item), more typically such physical paperwork is costly to obtain or is simply not available.

For at least these reasons it would be advantageous if a new system and method could be developed that in at least some embodiments allowed independent jewelers to provide, in a simple and cost-effective manner, information to consumers regarding the grade, quality and/or value of their jewelry, particularly (although not limited to) jewelry in the less expensive to inexpensive price range. It further would be advantageous if in at least some embodiments such information could be generated in a consistent, reliable manner and/or in a manner with sufficient safeguards such that, regardless of whether the information was actually determined by an independent third-party, the information properly could be considered to be accurate and unbiased and could be marketed to consumers as such. Also, it would be advantageous if in at least some embodiments such information could be provided to consumers in a format that buttressed consumers' sense of the value of the information. Further, it would be advantageous if in at least some embodiments such information, and other information, relating to purchased jewelry items and the certificates pertaining to those jewelry items could be easily collected, stored, accessed and/or updated.

Additionally, it would be advantageous if a new system and method could be developed that in at least some embodiments allowed a prospective buyer of a jewelry item to more easily obtain proof (or at least evidence in support) of the prospective seller's ownership of (or other authority to sell) the jewelry item to the prospective buyer. In at least some embodiments, it would be desirable if the new system and method allowed such verification information to be provided in relation to a prospective seller, even though that prospective seller was not necessarily the original retailer of the jewelry item.

### BRIEF SUMMARY OF THE INVENTION

The present inventors have recognized that, despite the fact that independent local jewelers are generally capable of making competent determinations regarding the grade/quality/value of jewelry items by themselves, there nevertheless remains a need for a system or method that would in at least some embodiments enable independent local jewelers to provide such grade/quality/value information to consumers in a simple, inexpensive manner that not only satisfied consumer desires in terms the presentation, format, or appearance of such information but also satisfied consumer desires for having accurate, unbiased and independent information.

Having recognized this need, as well as the general competency of independent local jewelers in making determinations regarding the grade/quality/value of jewelry items, the inventors have further recognized that this need can be satisfied in at least some circumstances by (i) providing independent local jewelers with a standardized or semi-standardized process and/or system for creating/providing certificates (or similar printed materials) to customers concerning the grade, quality and/or value of individual jewelry items at the local points of sale, e.g., within the local jewelry stores themselves; (ii) providing customers with an independent, third-party guarantee or warranty that the certificates are accurate, such that refunds or other benefits are provided to customers who demonstrate that certificates issued to them are incorrect; and (iii) empowering the third party guarantor/insurer with the ability to take stringent enforcement actions against those local jewelry stores that mistakenly (or fraudulently) happen to issue incorrect certificates, thereby maintaining the reputation and integrity of the overall certificate-issuance system.

Given such considerations, it has been further recognized that a new system can be created for creating certificates that includes a set of first local system components that include both a printer for printing certificates and a user interface by which information concerning the jewelry items can be input for printing onto certificates by way of the printer, the information typically (though not necessarily) being input to the terminal by the local independent jeweler at which the first local system components are located. In at least some embodiments, the printer is further at least temporarily in communication with a camera device by which one or more photographs of jewelry items can be obtained, and the printer in turn is able to print graphical images of the jewelry items on the certificates in addition to other information.

In at least some additional embodiments, these local system components are in communication with a remote, central terminal by way of the internet or other communication network(s), and information regarding jewelry items as well as possibly software program information and related data for operating the camera device, printer and other local system components can flow between the central terminal and the local system components. The remote, central terminal can be operated, for example, by a third-party guarantor/insurer of the certificates. In at least some embodiments, portions of the information at the central terminal can further be accessed by a variety of other users, consumers, guarantors, insurers/reinsurers or independent jewelers using their own local system components of various types. In some of these embodiments, such other parties can access the information by way of the internet, where the central terminal (or other appropriate device operated or controlled by the third-party) operates as a web server capable of sending webpages to web clients of those other parties and receiving information therefrom.

Also recognized is that, in at least some embodiments, it would be possible for a third party such as that mentioned above not only to provide or guarantee certificates pertaining to jewelry items, but also it would be possible for such a third party to maintain records of who is currently, and who in the past has been, the owner of a given jewelry item. Additionally, it has been recognized that, if some or all of such information was available at the third party, it would additionally be possible to allow prospective sellers, including prospective sellers who are downstream of the original retailers/sellers of jewelry items, to provide information to prospective buyers (or allow those prospective buyers to obtain information) verifying that the prospective sellers actually own or otherwise have authority to sell the jewelry items. In some such embodiments, additional information regarding the jewelry items being sold can also be made available to prospective buyers. Additionally, in some such embodiments, access to such information can be granted to prospective buyers who are able to enter in one or more appropriate codes into a website of the third party.

More particularly, then, the present invention in at least some embodiments relates to an internet-based method for accumulating, storing and providing jewelry-related information. The method includes preparing a plurality of certificates relating to jewelry items, where the certificates contain jewelry-related information including respective certificate numbers and respective other information regarding the jewelry items. The method additionally includes storing the certificate numbers and the information regarding the jewelry items in a database that is at least one of operated and controlled by a first entity that serves to offer at least one of guarantees and warranties in relation to the certificates. The method further includes providing at least some of the jewelry-related information onto the internet for receipt by a computer system that is at least one of operated and controlled by an additional entity that is at least one of a retailer, a wholesaler and a customer.

The present invention further relates in at least some embodiments to an internet based system for accumulating, storing and distributing jewelry-related information concerning jewelry items for which certificates have been issued. The system includes a database associated with a first entity that at least one of guarantees and provides warranties regarding the jewelry items for which the certificates have been issued, where the database stores the jewelry-related information including pertinent certificate identification information. The system also includes a web server in communication with the database, where the web server is configured for communication with the internet so as to receive messages off of the internet and to provide at least one webpage onto the Internet. The at least one webpage includes at least one of: a first webpage configured to receive first user-input information identifying a search request concerning the jewelry-related information; a second webpage capable of displaying at least some of the jewelry-related information; and a third webpage capable of receiving second user-input information concerning creation of a new certificate.

Additionally, the present invention in at least some embodiments relates to a system for managing retail sales of jewelry items and providing customers with warranties concerning their purchased jewelry items. The system includes means for recording information relating to the retail sales of jewelry items by a primary company to customers, and means for providing customers with certificates relating to their respective purchased jewelry items, where each of the certificates represents a warranty with respect to at least one of the purchased jewelry items, and where the warranty is backed by a secondary company.

Further, the present invention in at least some embodiments relates to a method of verifying ownership of a first jewelry-related item. The method includes receiving a certificate number associated with a first certificate corresponding to the first jewelry-related item at a mobile device capable of internet access, and sending the certificate number from the mobile device for receipt by an internet accessible central terminal that is at least one of operated and controlled by an entity that provides guarantees or warranties in relation to a plurality of certificates that respectively pertain to respective jewelry items, the plurality of certificates including the first certificate. The method additionally includes receiving ownership data pertaining to the first jewelry-related item at the mobile device from the central terminal, and displaying the ownership data on the mobile device.

Also, the present invention relates in at least some embodiments to a method of facilitating verification of ownership of a first jewelry-related item. The method includes receiving at a central terminal, from a mobile device via an internet-type communications medium, a certificate number associated with a first certificate corresponding to the first jewelry-related item, where the central terminal is at least one of operated and controlled by an entity that provides guarantees or warranties in relation to a plurality of certificates that respectively pertain to respective jewelry items, the plurality of certificates including the first certificate. The method additionally includes searching a database associated with the central terminal for ownership data pertaining to the first jewelry-related item, and sending the ownership data from the central terminal for receipt by the mobile device.

Further, the present invention in at least some embodiments relates to a system for verifying ownership of a first jewelry-related item. The system includes a central terminal that includes a database, where the central terminal is at least one of operated and controlled by an entity that provides guarantees or warranties in relation to a plurality of certificates that respectively pertain to respective jewelry-related items, the plurality of certificates including a first certificate pertaining to the first jewelry-related item. The database stores not only certificate data regarding the plurality of certificates but also additional data pertaining to the jewelry-related items, the additional data including ownership data indicative of a current owner of the first jewelry-related item, and the central terminal is capable of being accessed by way of a remote terminal communicating with the central terminal via an internet-type communications medium. Additionally, the central terminal sends the ownership data onto the internet-type communications medium for receipt by the remote terminal in response to receiving a certificate number corresponding to the first certificate.

### BRIEF DESCRIPTION OF THE DRAWINGS

FIG. 1 shows in schematic form a first embodiment of a system for providing information to consumers regarding characteristics of jewelry items;

FIG. 2 shows in schematic form a second embodiment of a system for providing information to consumers regarding characteristics of jewelry items, which includes certain local components in communication with a remote, central terminal;

FIG. 3 is a flow chart showing exemplary steps of operation of the system of FIG. 2;

FIGS. 4-34 are exemplary screen shots of webpages of a website that is made available to consumers, retailers and/or wholesalers utilizing the system of FIG. 2 or a similar system in accordance with certain embodiments of the present invention;

FIG. 35 is a flow chart showing exemplary steps of operation that can be performed by a remote terminal, such as a mobile device operated by a customer, in allowing the customer to obtain verification information regarding a jewelry item, in at least some embodiments of the invention; and

FIGS. 36-42 are exemplary screen shots of a remote terminal, such as a mobile device, on which is running an application by way of which the exemplary steps of FIG. 35 are performed.

### DETAILED DESCRIPTION OF THE. PREFERRED EMBODIMENT

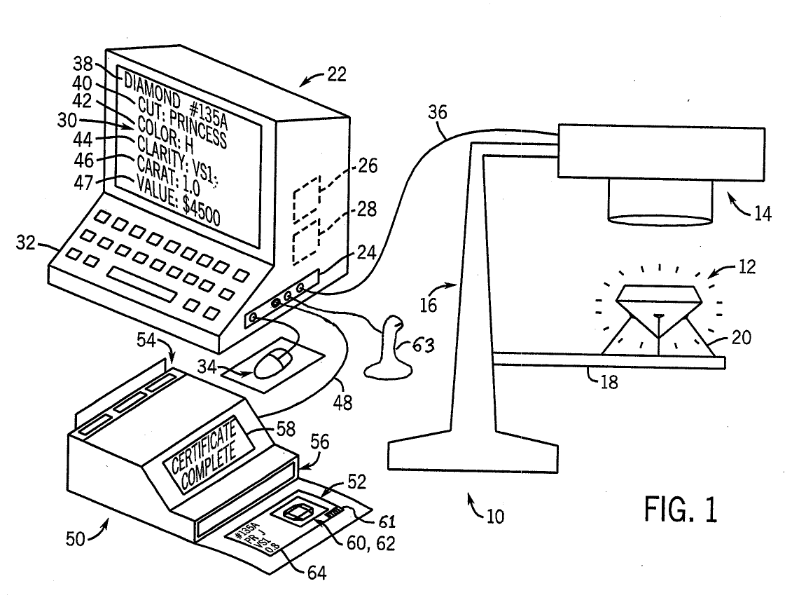

Referring to FIG. 1, components of a first exemplary system 10 for providing printed information to consumers regarding jewelry items such as a first jewelry item 12 are shown. In the embodiment shown, the system 10 includes a camera device 14, a computer terminal 22 providing a user interface, and a printing device 50. The camera device 14, which is supported upon a stand 16, is capable of taking images and/or otherwise obtaining image-related information concerning the first jewelry item 12. In preferred embodiments, the camera device 14 is able to obtain and provide image data on a very rapid (or immediate or nearly immediate) basis. In the embodiment shown, the first jewelry item 12 is also supported by the stand 16, by way of a ledge 18 and various support arms 20. However, in alternate embodiments, the jewelry item 12 can be supported by way of another support device than that shown and need not be supported by the stand 16 for the camera device 14.

The camera device 14 is intended to be representative of any of a variety of devices capable of obtaining image information that is suitable for obtaining image information regarding imaging characteristics of jewelry items such as the jewelry item 12. The camera device 14, therefore can be representative of a variety of digital cameras, film photography cameras, moving picture cameras such as camcorders and video cameras, and a variety of other devices. Depending upon the embodiment, the camera device 14 can be understood to include the stand 16 (and ledge 18 and support arms 20).

Also included within the system 10 is the computer terminal 22 that includes an input/output interface 24, a memory unit 26, and a processing unit 28, which can be, for example, a microprocessor or other computer processor or other processing device known to those of ordinary skill in the art. The computer terminal 22 additionally includes a video screen 30 on which can be displayed various information (e.g., text information as well as graphical information) and a keyboard 32. In the embodiment shown, the computer terminal 22 further includes a peripheral input device shown to be a mouse 34 that is coupled to the rest of the computer terminal 22 by the input/output interface 24. The computer terminal 22 is capable of receiving the image information regarding the first jewelry item 12 from the camera device 14 by way of a communication link 36 coupling the camera device 14 and the computer terminal 22. Additionally, the computer terminal 22 is capable of receiving additional information regarding the first jewelry item 12 as input by a user by way of the keyboard 32 and/or the mouse 34.

The jewelry item 12 is intended to be representative of any of a variety of different types of jewels and jewelry items including, for example, precious stones (for example, diamonds, rubies, emeralds), rings, pieces of jewelry having jewels embedded therewithin, necklaces, and a variety of other types of jewelry made of a variety of materials such as gold, silver and platinum. In the example where the first jewelry item 12 is a diamond as shown in FIG. 1, the user input information that is entered by way of a user at the keyboard 32 and/or the mouse 34 can be, for example, information such as that shown on the screen 30, namely, jewelry identification information (e.g., a diamond identification number) 38, a diamond cut 40, a diamond color rating 42, a diamond clarity grading 44, a diamond carat value 46 and an estimated monetary value of the diamond 47 (e.g., in the example shown, the diamond is number 135A, and is a H color, VS1 princess cut 1.0 carat diamond having an estimated value of $4500).

In the embodiment shown, each of the types of information 38-47 are input by a user via the keyboard 32 and/or the mouse 34; however, in alternate embodiments, some portions of this information could be obtained in other ways, for example, a color rating for the first jewelry item 12 could be determined by way of the camera device 14. In some embodiments, the screen 30 is further capable of displaying the image information obtained via the camera device 14 or information based in part upon that image information (e.g., an image showing a part of the jewelry item in detail). The information received by way of the camera device 14 and by way of the keyboard 32 and/or mouse 34 can be stored in the memory unit 26 of the computer terminal 22, as well as processed by way of the processing unit 28.

The computer terminal 22 is further coupled, by way of a second communication link 48 also connected to the input/output interface 24, to the printing device 50. The printing device 50 allows for the printing of certificates such as a certificate 52 that contain all of, or one or more portions of, the image information provided by the camera device 14 and the other information input by the user by way of the input devices 32, 34 (e.g., the information 38-47), or information that is based upon that image information and/or user input information. The printing device can be any of a number of different printing devices known to those of ordinary skill in the art that are capable of printing hard copies of documents on paper or similar materials to obtain certificates, business cards and/or other printed media on which various textual, graphical (including, for example black and white and/or color images) and/or other information is shown. For example, the printing device 50 can be a laser printer, a dot matrix printer, or other types of printing devices.

Typically, the printing device 50 will, as shown, include an input port 54 at which a user can insert a Hank piece of paper or other blank or partly-printed medium and an output port 56 at which a completed certificate such as the first certificate 52 or other printed medium is output. Depending upon the embodiment, the printing device 50 also can have a display 58 that indicates information such as printing status (in the example shown, a certificate has just been printed and consequently the display shows “certificate complete”). Depending upon the embodiment, the printing device 50 can be directly controlled by the computer terminal 22 by way of the communication link 48 or, alternatively, can be partly or entirely self-controlled, in which case the printing device 50 requires only some or no control commands from the computer terminal and primarily receives only data from that terminal 22.

The printed certificate 52 (or other printed medium) can display a variety of information regarding one (or potentially more then one) jewelry item such as the jewelry item 12. In the example shown, an image 60 (for example, a clear, full color digital quality photo) is provided on a right side 62 of the certificate 52, while the input information 38-47 is provided in modified form along a left side 64 of the certificate. In certain embodiments, the certificate 52 is laminated/plastic coated to improve the longevity of the document. While in some embodiments, the certificate is relatively large in size (e.g., 8½ by 11 inches), in other embodiments the certificate can be smaller in size such as the size of a business card. Also, the color and various ornamental/design features (e.g., the look of the certificates) of the certificate can vary depending upon the embodiment. In some embodiments the certificates can be numbered (to allow for accounting/tracing of issued certificates), or include other identifying marks or indicia. In certain preferred embodiments, and as shown in FIG. 1, the certificate also includes one or more bar codes 61 that are indicative of the identity of the certificate and/or various information contained on or otherwise associated with the certificates. Relatedly, the present system 10 also includes a bar code scanner/reader 63 that can be used to read the bar codes on the certificates. The bar code information, when read, can be utilized by the system to quickly determine the identity of a particular certificate after it has been printed. As discussed in further detail below, depending upon the circumstance in which the bar code information is read (and/or additional information input by a user interacting with the system), scanning of a bar code on a certificate can serve as an indication that a jewelry item has just been purchased, that the corresponding certificate has just been validated, or that the jewelry item associated with the certificate has undergone some transaction or transition, for example, the jewelry item was cleaned, fixed or otherwise maintained subsequent to its purchase.

Depending upon the embodiment, the certificates can also list additional information such as warranty policy information, and phone number/other contact information regarding who to contact in the event of a question or problem regarding the certificate or the jewelry items(s) that are the subject of the certificate. Further information regarding the possible contents of certificates depending upon the embodiments are discussed below with reference to FIGS. 11-13, among others. In some embodiments, the printed certificates or other printed material is accompanied by other items; for example, outer display boxes (e.g., ring boxes) and other containers can be provided to hold both the jewelry items sold and the certificates, wallets can be provided to hold business-card-sized printed certificates, and counter support material and signs/posters can be provided as well.

The components of the system 10 can be varied, in alternate embodiments, from those shown. For example, in certain embodiments, the computer terminal 22 can be replaced with a simpler user interface that does not use its own memory unit to record user input information or its own processing unit to process such information or information received from the camera device 14. In such embodiments, each of the camera device 14 and the user interface can be directly coupled to the printing device 50, which would in some such embodiments include its own memory and/or processing capabilities for handling information received from the user interface and the camera device. That is, in such embodiments, the printing device can be the “smart” device while each of the camera device and the user interface can be relatively “dumb” machines.

The exact features of the user interface, whether included as part of the computer terminal 22 as shown or whether as part of some other device, can vary to include touch screens, hand-held devices such as personal digital assistants, and other input/output devices known to those of ordinary skill in the art. The communication links among the various components of the system can also be modified from that shown in FIG. 1; for example, each of the components could be coupled to a network rather then by way of the direct, dedicated communication links 36 and 48. In still further embodiments, the camera device 14 can include various memory and processing components allowing for more complicated processing of the imaging information and/or other information such as that provided by way of user interface. In other embodiments, two or more of the computer terminal 22, camera device 14 and printing device 50 can be physically incorporated into a single device.

In the embodiment of FIG. 1, all of the components of the system 10 can be located at the point of sale. While it is possible that in certain embodiments each of the camera device 14, the printing device 50 and the user interface (of the computer terminal or otherwise) would be strictly hardware components, typically one or more of these devices will operate based at least in part upon software programming and related data. Such programming used by the computer terminal 22 and/or the other devices such as the camera device 14 and the printing device 50 can be provided when the system is purchased, for example, in the form of a floppy disc or a CD ROM containing such programming, information that can be loaded onto the computer terminal 22. Typically, such software would enable communications of information among the various devices of the system 10 as well as enable processing of such information, such as imaging processing.

In certain embodiments, the software provides a graphical user interface on the computer terminal 22 that includes one or more windows having finable blank portions that can be filled with data by a user or edited, such that a user can edit various jewelry-related and other information (e.g., edit a jewelry item grade or replacement value). Also, in certain embodiments, such a graphical user interface would allow for a prescreening of any image obtained by the camera device 14 and processing of that image device (e.g., rotation, changing of colors, tint, gray scale, size and other image characteristics known to be modifiable by those of ordinary skill in the art). Further, in some embodiments, the software would include programming allowing for estimates of jewelry items' value to be calculated based upon other information input by users, such as the diamond-related information shown as information 38-46 on FIG. 1 or certain market-related information.

Although the embodiment of FIG. 1 can operate in a manner that is independent of communications with any outside systems or networks (e.g., the internet), as discussed below certain embodiments of the present invention envision that the system 10 (or similar system) would be coupled to the internet and, via the internet, be in communication with other devices. Additionally, in some such embodiments, the graphical user interface provided on the computer terminal 22 can be created through the use of a standard browser program that, upon receiving webpages off of the internet, then displays those webpages.

In general, the present invention is intended to encompass all systems such as the system 10 that can be at least partly located at the point of sale of jewelry items, particularly, for example, at independent jewelry stores, and that can be utilized by sales people and others at those points of sale to generate certificates or similar printed material on which information regarding the jewelry items' grade, value, quality or other related characteristics can be provided to customers. Typically, to determine quality, grading and valuation information regarding the jewelry items, the systems depend exclusively or at least largely upon information that is determined and provided by the operators of the systems at these local points of sale, e.g., the local jewelers themselves. Reliance by consumers upon such certificates generated by independent jewelry stores is largely justified in most instances simply by the fact that independent jewelers are typically competent in determining these types of information on their own.

Although reliance upon certificates created by independent jewelry stores is justified in most instances, the present invention recognizes that the perceived and actual value of such certificates to customers could be enhanced by a further guarantee that the certificates are accurate. For this reason, in preferred embodiments of the present invention, the certificates (or other printed information) are backed up by another “secondary” company or other entity that typically is unaffiliated with the independent jewelry stores providing the certificates. The secondary company provides a warranty or guarantee that the printed information on the certificate is in fact accurate, thus effectively providing a customer with insurance covering the risk that the particular independent jeweler with Whom the customer is dealing is both competent and trustworthy. The name of the secondary company would be listed on the printed certificate, indicating that the secondary company guaranteed that the information on the certificate was correct.

In the event that a customer came to believe that the information provided on a certificate issued in relation to a purchased jewelry item was inaccurate, the customer could send in the certificate and jewelry item for reevaluation by the secondary company. Upon determining that there was a problem, the secondary company in turn could provide a refund to the customer, for example, a refund of the difference between the value of the jewelry item as listed on the customer's certificate and the value of the jewelry item as determined by the secondary company (or a refund of the difference between the value of the jewelry item given the quality/grading information listed on the certificate and the actual value of the jewelry item). Also, a reissued, corrected certificate could be provided to the customer. The secondary company could further demand reimbursement of the refunded money from the original jeweler that issued the certificate and if such reimbursement was not forthcoming, prohibit the original jeweler from continuing to issue certificates in the secondary company's name. In this manner, customer inquiries and complaints would serve as a “policing mechanism” by which the secondary company could maintain the quality and accuracy of the issued certificates.

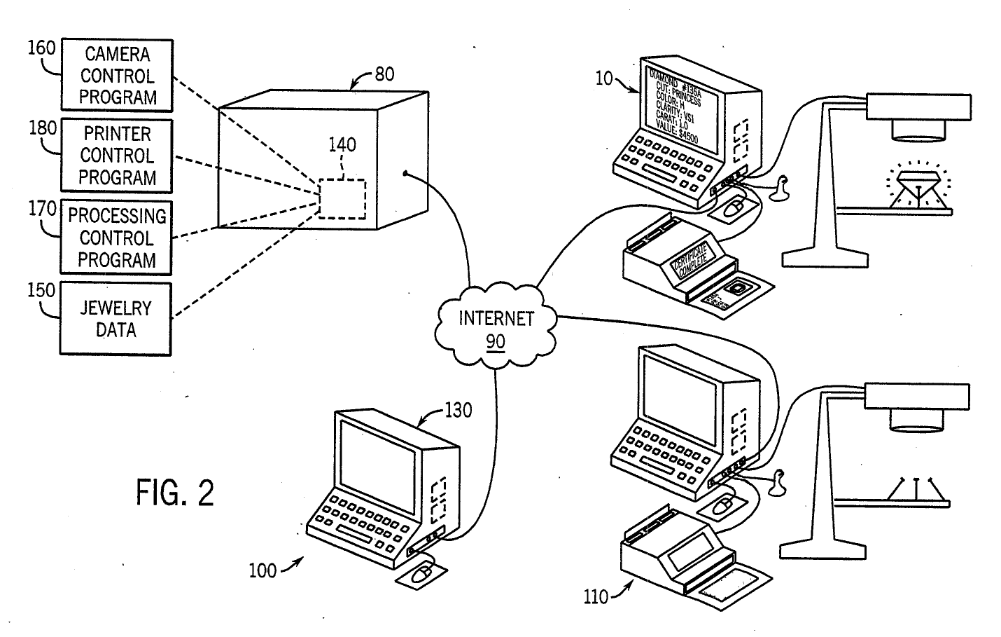

While in the above-described embodiment, the certificates are printed and issued exclusively by the independent jewelers, in alternate embodiments only first or “rough” drafts of the certificates (or possibly no certificates at all) are immediately printed and issued to consumers by the independent jewelers. In such alternate embodiments, “final” drafts of the certificates are subsequently printed and provided to consumers by the secondary company providing the warranty/guarantee (or possibly some other third party), and the final drafts of the certificates can take on a different form (e.g., a business-card size) than that of the rough drafts of the certificates (which might still be in an 8 1/2″ by 11″ format). The information provided on the final drafts of the certificates would still be largely if not entirely based upon information determined by the independent jewelers (which could be communicated to the secondary company either by sending the secondary company copies of the rough drafts of the certificates or electronically as discussed with respect to FIG. 2), and consequently the secondary company would still serve as a guarantor with respect to the certificates. In further alternate embodiments, rough drafts of certificates (or some portion of the certificate information, such as an image of a jewelry item) could be printed on receipts provided to customers.

Turning to FIG. 2, while in certain embodiments of the present invention (such as that shown in FIG. 1) the components of the system are localized at a point of sale such as the store of an independent jeweler, in other embodiments the system can include not merely local components at a single jeweler or other point of sale but rather can also include additional components at other locations. In the example of FIG. 2, a system 100 includes not only the system components 10 of FIG. 1 at a local point of sale, but further includes a central terminal 80 that is located remotely from the local components of the system 10. In the embodiment shown, the system 10 and the central terminal 80 are coupled by way of the internet 90, although in other embodiments dedicated telephone lines and other communication links known to those of ordinary skill in the art could be used instead or in addition to the internet.

The central terminal 80 in turn can be coupled to any one or more of a number of other systems at other locations or points of sale, such as an additional system 110 and an additional computer terminal 130. The systems at the various different locations need not have identical components, although in the embodiment shown systems 10 and 110 have such identical components. The additional computer terminal 130 in particular is intended to be representative of other devices, systems and/or parties that can be in communication with the central terminal 80 even though those parties are not themselves intending or able to create certificates for consumers.

The central terminal 80 can serve a variety of purposes depending upon the embodiment. In the present embodiment, the central terminal 80 includes one or more databases 140 that can store various information and/or programming. In particular, the database 140 can store jewelry-related information or data 150 that is uploaded from the various local systems such as the systems 10 and 110. Depending upon the embodiment, the jewelry-related data 150 uploaded from the local systems such as systems 10 and 110 can include not only graphical and textual data pertaining to jewelry items per se (e.g., images, as well as grading, quality, or valuation information) but also name, address and other customer-related information regarding the customers who have purchased (or even have considered purchasing) particular jewelry items from the independent jewelers operating the local systems, as well as certificate identification numbers, certificate-issue dates and other information regarding certificates that have been issued by way of the local systems (e.g., amounts of insurance coverage provided with respect to different certificates).

Storage of this information at the central terminal 80 allows this information to be maintained indefinitely for later access both by the independent jewelers who have entered or developed this information and provided certificates based upon this information, as well as by customers who have been issued certificates, as well as by potential third-parties who are interested in the jewelry data. Such third-parties can include other independent jewelers at points of sale other then those which have created the jewelry data, as well as other third-parties who merely wish to inquire about this information (including potentially other retailers or wholesalers). Subject possibly to appropriate restrictions and controls, such customers, other independent jewelers and other third-parties can access some or all of this information stored at the central terminal 80, for example, by way of the additional computer terminal 130 or other similar terminals.

In certain embodiments, the database 140 stores all data associated with certificates that have been created and/or issued to customers who have purchased jewelry-items. Preferably, the databases 140 store and organize information in a manner that facilitates not only the efficient storage of such information but also allows for information to be retrieved, sorted and searched efficiently. Conventional search/retrieval software can be implemented on the databases 140 to achieve these goals. As discussed further below, the central terminal 80 in at least some embodiments allows for independent jewelers and others to enter search queries that cause the central terminal 80 to identify and retrieve relevant information from the databases 140 (e.g., all certificates issued by a particular independent jeweler).

Although not necessarily the case, the central terminal 80 typically is the property of, and/or operated by, one of the above-discussed secondary company or companies that serve to provide a guarantee/warranty/insurance regarding issued certificates. By receiving and analyzing the jewelry-related data 150 at the central terminal 80, it is possible not only for the secondary company to keep track of the activities of independent jewelers that are operating the local systems 10, 110 and creating and issuing certificates (or taking appropriate actions such that the secondary company creates/issues certificates), but also for the secondary company to maintain its own records of certificates that have been issued such that, in the event of a customer complaint, the secondary company is able to independently verify that the certificate information provided by the customer corresponds to the certificate information supposedly provided by the independent jeweler that issued the certificate and sold the related jewelry item.

The storage of certificate information at the central terminal 80 also allows the secondary company to provide an independent jeweler with an inventory and history of the certificates that have been issued by that independent jeweler and/or other independent jewelers. In some embodiments, an independent jeweler can access the central terminal 80 and obtain (and print out) information regarding the certificates that have been issued by the jeweler, including information sorted by type/category of certificate (for example, a listing of all certificates that have been issued for jewelry items within a certain price range), as well as print out additional copies of the issued certificates themselves. Also, the independent jeweler can access the central terminal 80 to obtain a mailing list of all for a subset of the) customers to which the jeweler has issued certificates.

In some circumstances, when information regarding a particular jewelry item has been determined by one of the local systems 10, 110 but the jewelry item to which the information pertains did not end up being sold, the uploading of that information to the central terminal 80 can facilitate the later sale of that jewelry item by other retailers who have access to that information even though they do not have that jewelry item in their possession. In some embodiments, for example, all retailers (or at least retailers that are licensed to access the central terminal 80) are able to access wholesale price and pictured inventory information stored on the databases 140. Further, in some embodiments, customers are able to access this information regarding unsold jewelry items by way of their own computers (e.g., over the internet) or other terminals such as the additional computer terminal 130. To the extent that certificates were created concerning the unsold jewelry items, certificate information can also be made accessible.

in some circumstances, such customers are further able to purchase jewelry items using their own computers by contacting the central terminal 80 and appropriately interacting with the central terminal. In this manner, the secondary company associated with the central terminal 80 can operate as a middleman between a customer desiring a jewelry item and an independent jeweler in possession of the jewelry item. In such circumstances, customers again can potentially access the photographic (or other graphical) information regarding the jewelry items, as well as the grading/quality/value/price information concerning the jewelry items and/or certificate information. Thus, in certain embodiments, the information stored at the central terminal 80 can be accessed and utilized by wholesalers, retailers, customers (e.g., customers on the internet) and others to further promote the sale of jewelry items.

in further embodiments, customers, potential customers, or other parties can also access the central terminal 80 to obtain various other information such as, for example, a listing of independent jewelers or others who are licensed, qualified, authorized or otherwise able to issue certificates that are recognized by the secondary company (or to check if a particular entity is so licensed), the capability to search for such licensed independent jewelers or other parties (e.g., by way of state or zip code), information regarding how jewelry items such as diamonds are graded (e.g., charts and other information regarding grading standards such as those used by recognized grading companies), and information regarding how to obtain casualty loss and other similar types of insurance for jewelry items (e.g., a list of insurers, exemplary insurance prices, and other related information). Also, it is possible for customers, potential customers and others to obtain information regarding the guarantee/warranty program sponsored by the secondary company including, for example, answers to common questions, information regarding the actual guarantees/warranties offered by the secondary company, and contact information.

Also, by recording this information at the central terminal 80, it is possible to determine when appraisal values or other time-varying characteristics of jewelry items may have changed sufficiently that issued certificates should be updated, and consequently can facilitate a program of offering updated certificates to consumers who have been issued certificates (in some embodiments, information stored at one of the local systems such as the system 10 can also be used for this purpose). In some circumstances (e.g., when an appraisal update package is purchased by a customer), updates to an issued certificate will be regularly (e.g., annually) generated and provided to a customer who have been previously issued the certificate. In other embodiments, reminders will be periodically sent to customers to have their jewelry items reappraised. Also, in certain embodiments, the maintenance histories of jewelry items can be stored and recalled. Further, in some such embodiments, it can be determined automatically when jewelry items should be cleaned, inspected, or otherwise undergo maintenance processes. When such determinations are made, reminders can in turn be sent out to the customers.

Additionally, if the central terminal 80 is owned, operated by and/or otherwise associated with a secondary company as discussed above, the maintaining of the jewelry information at the central terminal 80 facilitates the ability of the secondary company to act as a final arbiter of whether representations made on the certificates are in fact accurate, as discussed above. Thus, in the event that a customer believes that certain information on an issued certificate is incorrect, the customer can provide the certificate number along with the jewelry item to which it pertains to the secondary company. If the secondary company determines based upon the information in the central database 80 corresponding to the certificate number that the information on the certificate is in fact false or inaccurate, the independent entity can refund some or all of the purchase price of the jewelry item to the customer and, at the same time, identify the independent jeweler/retailer who developed the erroneous certificate. Also, by keeping track of which certificates are owned by which independent jewelers, the second company can provide customers with information about the performance of those independent jewelers over time.

As indicated in FIG. 2, the central database 140 of the central terminal 80 in some embodiments can also store/include various programs and related information for governing the components of local systems such as, for example, a camera control program 160 for controlling camera devices such as the camera device 14, a processing control program 170 for controlling image or other data processing performed by a component such as the computer terminal 22, and also a printer control program 180 capable of controlling the operation of printing devices such as the printing device 50. In some embodiments, the control program 170 further includes programming that allows for communications between the central terminal 80 and the local systems 10, 110 (or terminal 130). In some circumstances, the systems 10, 110 could be configured to automatically communicate/interact with the central terminal 80 without user instruction. For example, in one embodiment, the systems 10, 110 could be programmed to send certificate-related information to the central terminal 80 whenever a certificate was printed out or otherwise issued. Also, in certain embodiments, one or more of these programs could be downloaded to the local systems 10, 110 when those systems are first initially brought on line by an independent jeweler or retailer. Once downloaded and installed, the programs would not need to be repeatedly downloaded except in situations where the programs needed to be updated or corrected.

In some embodiments involving internet-based communications, a server program at the central terminal 80 would be capable of communications with one or more web clients such as the local systems 10, 110 and potentially at other locations as well, such as the terminal 130. In such embodiments, the central terminal 80 would provide a website having one or more webpages that were accessible by browser programs at the local systems by way of the internet. In at least some such embodiments, the communications occur via the “World Wide Web” supported by the internet, which is understood by those of ordinary skill in the art to include one or more networks that are in communication with one another by way of standardized protocols such as the TCP/IP protocol. Further, in some such internet based embodiments, the central terminal 80 would provide information in the form of Java applets to the browser programs, to allow for the display of particular information (including graphical images, textual information, hyperlinks and other information pertaining to certificates, etc.) at the local systems 10, 110, terminal 130 or other locations constituting web clients.

More specifically, in some such internet-based embodiments, each of the local systems 10, 110 and 130 and terminal 80 is connected to and capable of communicating with the internet by way of any of a variety of communications devices including, for example, a modem and telephone line, a digital connection such as an ISDN telephone line, wireless communications devices, a local area network (LAN), etc. Each of the local systems 10, 110 and 130 employs a computer system having one or more processor units, video displays and/or other output devices (e.g., a “monitor”), and input devices (e.g., a keyboard and/or a mouse), such as that shown in FIG. 1 or other similar components. The computer systems each have, for example, a standard Microsoft Windows/Intel Microprocessor (“WINTEL”) architecture and also employ a standard browser program such as Internet Explorer in order to communicate with the web server over the internet. Through their communications over the internet with the web server, the computer systems are able to download HTML-based webpages as well as other information that is relevant to the operation of and interaction with the website hosted by the central terminal 80 operating as the web server.

In other internet-based embodiments, a given local system such as the local systems 10, 110 and 130 would require the direct control of its operations at any given time by programming residing at the central terminal 80. For example, in one embodiment, a user at a local retailer would log onto the internet 90 by way of a browser program operating on the user interface. Upon establishment of communications between such browser program and a web server at the central terminal 80, the central terminal would then be in a position to govern operations of the components of the local system. Further, although FIG. 2 shows the overall system 100 as being capable of both uploading jewelry information to the central terminal 80 from the local systems 10, 110, downloading such jewelry information from the central terminal to the local systems as well as to possible third-party systems, and also the downloading of control programs to local systems or direct controlling of those local systems by way of the central terminal, the present invention is also intended to encompass embodiments in which only one or more of these different types of communications among the central terminal 80 and the various local systems or other third-party systems occur. Likewise, it is further possible for information to be provided to the central terminal from any or all of the local systems 10, 110 and 130 as well as from other systems.

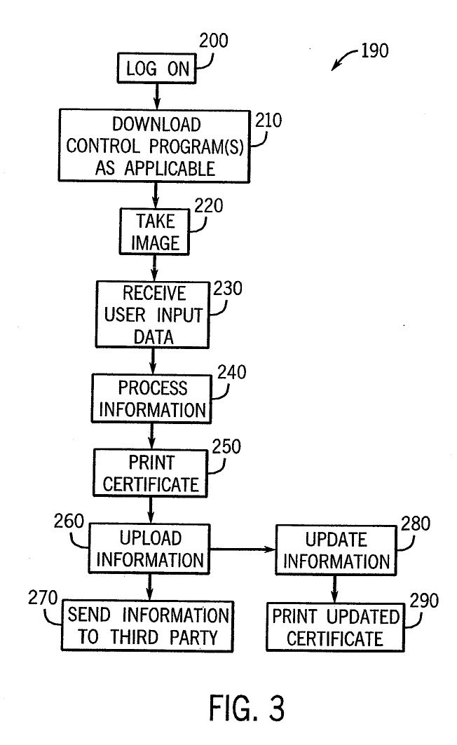

Turning to FIG. 3, a flow chart 190 shows exemplary steps of operation of the system 100. In a step 200, a user at one of the local retailer systems such as the system 10 logs onto the internet 90 by way of a browser program and establishes communications with a server program at the central terminal 80. Assuming that this is the first time that the local system has established communications with the central terminal 80, in this first interaction, the various control programs such as programs 160, 170 and 180 are downloaded at a step 210 from the central terminal to the local system, for example, to the computer terminal 22 of the system 10. Assuming, in the present example, that the central terminal 80 does not provide for continuous direct control of the local system, but rather that the local system controls its own operation by way of the downloaded control programs once they have been downloaded, the local system 10 is then capable of operating on its own to print certificates regarding jewelry items. Thus, at a step 220, when a jewelry item is provided for which a certificate needs to be made, the system obtains an image of that jewelry item by way of the camera device 14.

Further, at a step 230, the local system 10 further receives other information concerning the jewelry item such as information of the types 38-47 of FIG. 1. Next, at a step 240, the various image and other jewelry information is processed, for example, by way of the processing unit 28 implementing the downloaded processing control program 170. This information is provided then to a printing device such as the printing device 50, which prints a certificate based upon the information at a step 250. As discussed above, the printing of the certificates at step 250 can also be performed by a secondary company affiliated with the central terminal 80. The secondary company then would send the printed certificates to the customers who purchased the jewelry items.

Once a certificate has been printed (or at least once the information to be printed on a certificate has been assembled), the jewelry information is also uploaded to the central terminal 80 at a step 260. Once the central terminal 80 has that information it can further (at a step 270) be provided to other users of other local systems such as the system 110, as well as to other third parties who may desire that information, e.g., at terminal 130. The uploaded information can also be the basis for determining whether future updates to the information are necessary, and in some embodiments the central terminal 80 is capable of automatically or semi-automatically updating information in its own database 140 as well as automatically sending out notices to customers who have been issued certificates that updated certificates or other information is available, as indicated at a step 280. If a customer requests such an updated certificate, that certificate can be printed and provided to the customer at a step 290.

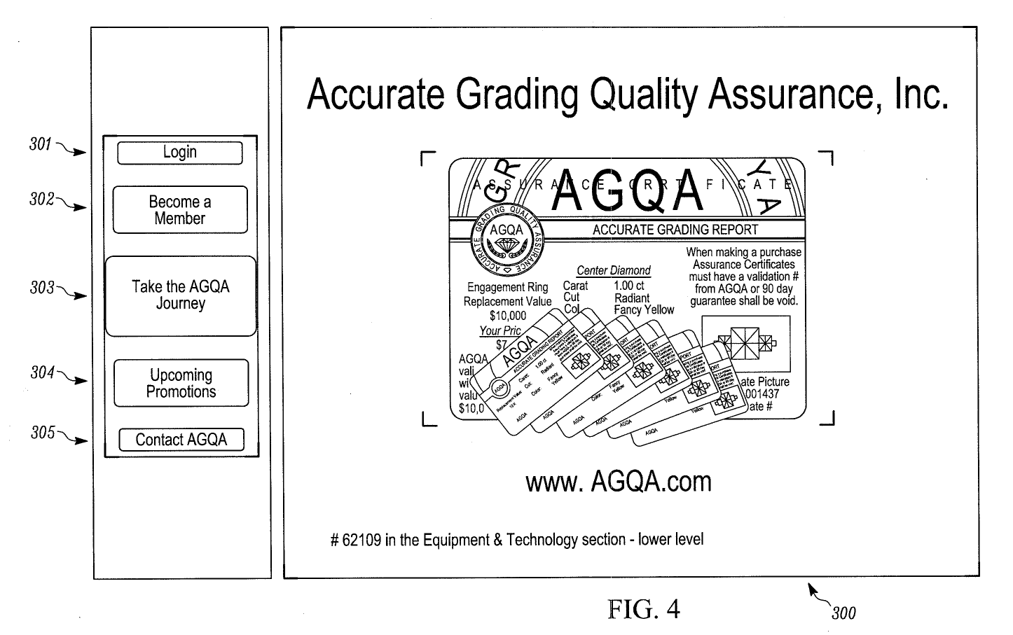

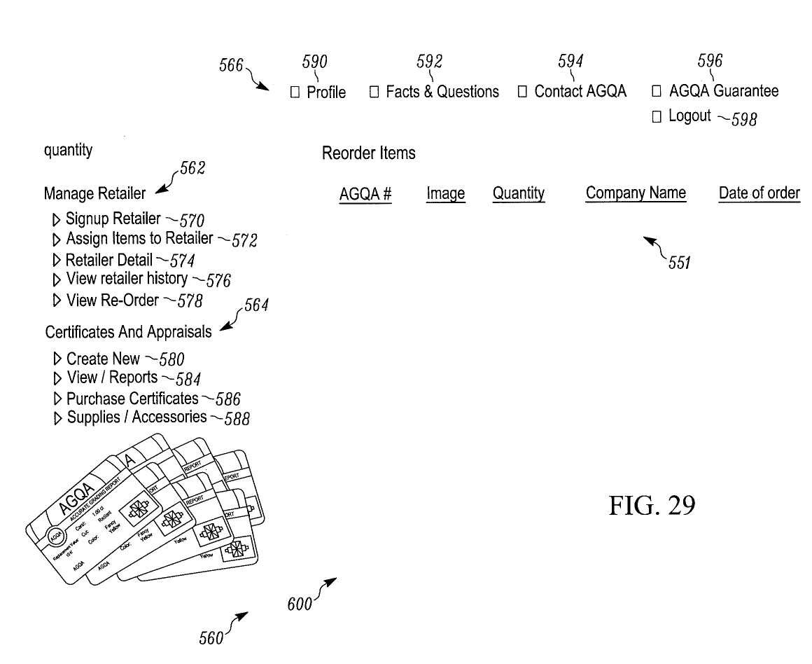

Turning to FIGS. 4-34, as discussed above, the system 100 shown in FIG. 2 in at least some embodiments is implemented in a manner that allows one or more retailers, wholesalers, and/or customers to interact with the overall system and in particular with the central terminal 80 operated by a secondary company, where it is the secondary company that serves to provide a guarantee/warranty/insurance regarding issued certificates. More particularly, such implementation can be achieved through an internet-based implementation in which the central terminal 80 serves as a web server capable of providing webpages that can be downloaded by terminals such as the computer terminals 22 associated with the systems 10, 110, the computer terminal 130, and/or other computer terminals (or other terminals) at which the internet can be accessed. Although in the present embodiment, the central terminal 80 and particularly the web server operating the website are operated and/or controlled by the secondary company, in other embodiments the secondary company could have varying degrees of direct control. For example, the website could be operated by an independent web hosting company indirectly in response to directions provided by the secondary company.

In the embodiment of FIGS. 4-34, the website is accessible to varying degrees by each retailer, wholesaler or customer who is involved with the certification program sponsored by the secondary company affiliated with the central terminal 80 (and possibly others). That is, each such party is eligible to access the website, at least to varying degrees. Further as shown particularly in FIG. 4, when one of these parties first accesses the website, a first webpage or home page 300 appears listing basic information about the secondary company (which in this case is Accurate Grading Quality Assurance, Inc. or “AGQA” of Janesville, Wis.). The home page 300 also includes several selectable buttons 301-305, which allow the user to take different actions. The first button 301 is a log in button that, when selected or pressed (e.g., by moving a cursor over the button using a mouse and “clicking” the mouse) allows a registered member of the program to access the website. Typically, upon pressing the log in button 301, the user is presented with an opportunity to specify whether the user is a retailer, a wholesaler or a customer, and then further to specify identification information, after which the user is allowed to enter the website.

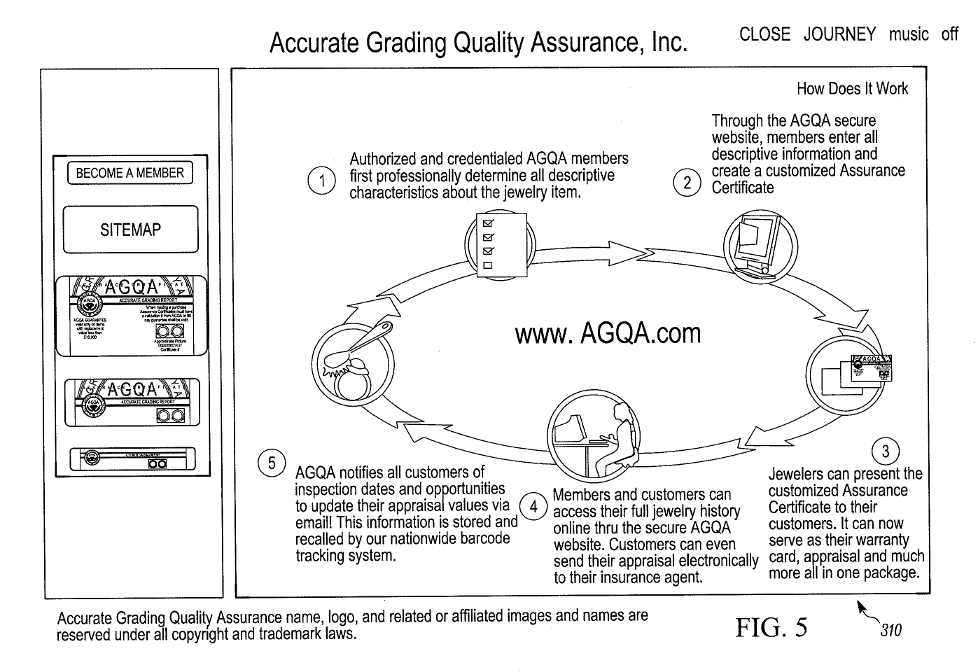

The third button 303 allows the user (typically regardless of the user's eligibility) to access various information about the certification program offered by the secondary company. Among the information that can be provided when the button 303 is pressed is shown in another webpage 310 illustrated in FIG. 5. As shown, the program offered by the secondary company in the present embodiment encompasses five steps. In a first step, authorized and credentialed members of the program (e.g., retailers) professionally determine descriptive characteristics about a given jewelry item. In a second step, the members (e.g., retailers) enter this descriptive information and create a customized certificate regarding the jewelry item. Then, at a third step, the certificate can be presented to customers, either a particular customer who is purchasing the jewelry item at that time or multiple customers who are interested in possibly purchasing the jewelry. When the certificate is provided to a customer who has purchased a related jewelry item, the certificate can serve as a warranty card, as well as an appraisal record and provide additional information.

In a fourth step, in accordance with the present embodiment of the program, members of the program including customers can access jewelry history on-line through the secure website of the secondary company. In certain embodiments, customers could even send their appraisal electronically to their insurance agents. Finally, at a fifth step, the secondary company notifies customers of certain information on a periodic or other appropriate basis. For example, the secondary company can send customers information regarding inspection dates or opportunities to update their appraisal values on their certificates, or maintenance recommendations or other information via e-mail. When certain activities are performed in relation to the jewelry item, for example, when the jewelry item is cleaned, that information can further be entered and stored into the system.

In a preferred embodiment, information relating to a jewelry item that arises subsequent to the creation of a certificate concerning that jewelry item can be entered into the system (at least at retail sites) at least in part through the use of a bar code tracking system when a bar code scanner in communication with the system is used to scan the certificate. When the certificate bar code is scanned, and the additional information regarding the activity performed in relation to the jewelry item has been specified, that information is automatically associated by the system with the other data stored in the system concerning that jewelry item as identified by the bar code. Such a procedure is particularly applicable where the certificate has been issued to a customer who has bought the related jewelry item. For example, if the customer brings the jewelry item into a retail store for cleaning, the retailer can scan the bar code on the customer's certificate and provide additional information into the system indicating that the jewelry item corresponding to that certificate bar code was cleaned. Such information then becomes part of the record corresponding to that jewelry item, and is potentially accessible by all retailers affiliated with the program sponsored by the secondary company in addition to the secondary company itself and the customer who owns the jewelry item.

Referring again to FIG. 4, the fourth button 304, when accessed, causes various information to then appear indicating upcoming events or promotions. The fifth button, when pressed, provides contact information regarding the secondary company or, in certain embodiments, simply causes an e-mail message window to pop-up by which the user could create and send an e-mail message to the secondary company.

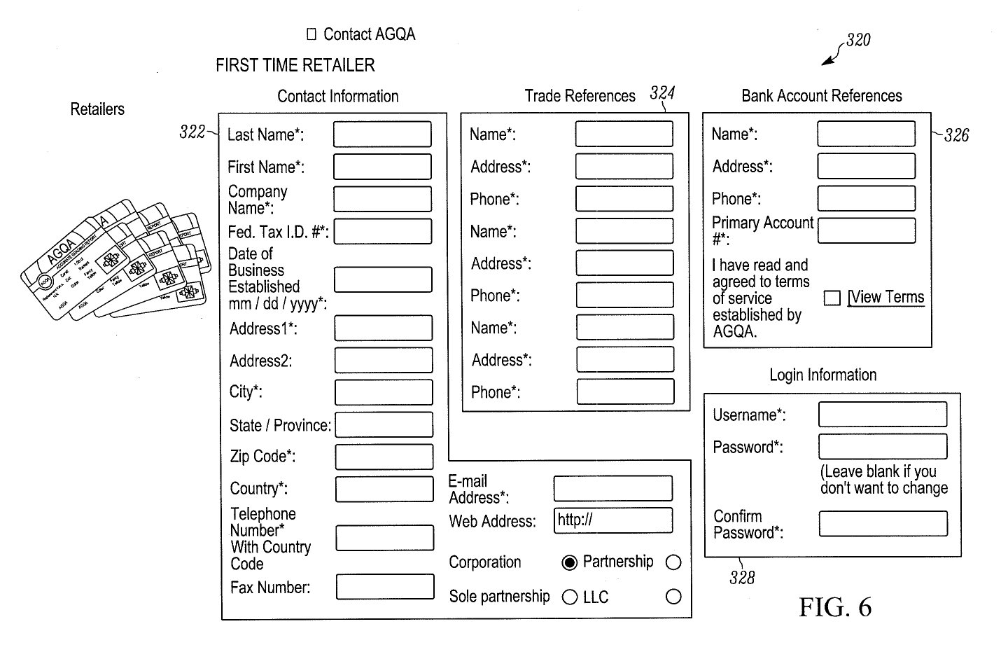

As for the second button 302 concerning becoming a member, when that button is pressed, the user is presented with an opportunity to become a registered member of the program sponsored by the second company by entering various information. As shown in FIG. 6, which shows a webpage 320, a user who intends to become a member as a retailer is asked to specify various information including contact information 322, trade reference information 324, bank account reference information 326 and log in information 328. The required information is entered by the user by typing the information into various fields and tabbing through the various fields. The particular information that is required by the webpage 320 is only intended to be exemplary, and can vary from program to program and system to system. The log in information 328, which requires that the first time retailer specify a user name and a password, follows a common format and typically will be required. Although not shown, a user who wishes to become a registered member as a wholesaler would complete a form provided by a webpage that are similar to those of FIG. 6, subsequent to the selection of the button 302 of FIG. 4.

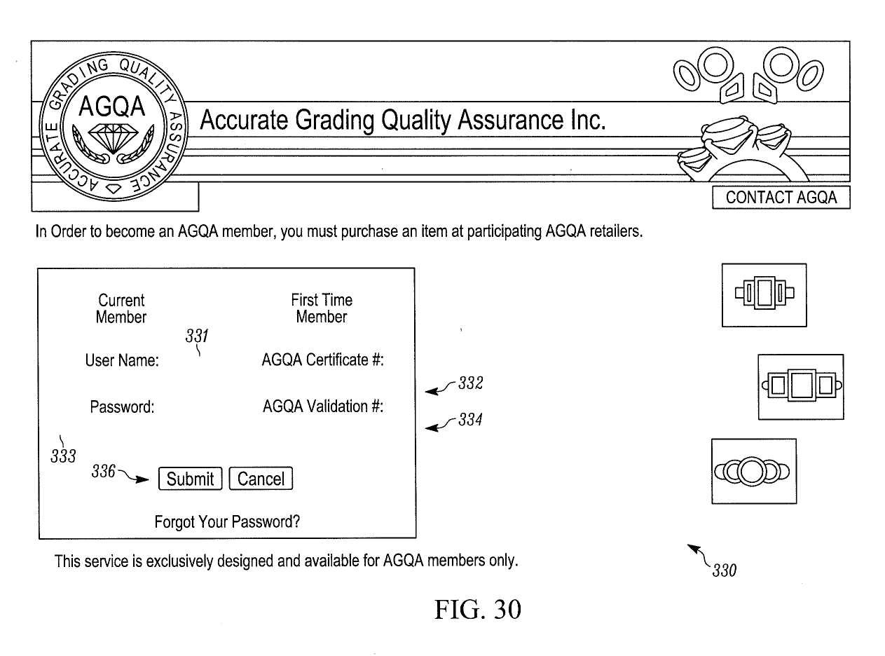

A first time customer/consumer would typically become a registered member by way of a different form/webpage than that of FIG. 6. As shown in FIG. 30, upon selecting the button 302 and providing an indication that he or she is customer/consumer, a webpage 330 would appear. In order for a user who is a customer to become a member of the program, the customer must have purchased a jewelry item that resulted in the issuance of a certificate (or possibly the sale of an already-issued certificate). Assuming that such a certificate was issued, the customer would have not only a certificate number associated with that certificate but also a validation number provided by the retailer or other entity that sold the customer the jewelry item. With those two numbers (or other types of codes, such as alphabetical codes), the user would enter a certificate number into a first field 332 of the webpage 330 and a validation number into a second field 334 of that webpage and, upon doing so, press a submission button 336. Once that information was submitted, the user would be presented with additional fields corresponding to the log in information box 328 shown in FIG. 6 in which the user could specify a user name and password. After specifying appropriate user name and password information, the customer would be approved as a member.

Once a retailer, wholesaler or customer has become a registered member for the first time, the retailer, wholesaler or customer can from then on log in into the website by way of its corresponding username and password information after pressing the log in button 301 (such users also would typically become logged into the system immediately subsequent to the registration process). The degree or type of access that is possible for a given user will vary depending upon the type of user, e.g., depending upon whether the user is a retailer, wholesaler or customer, as discussed further below.

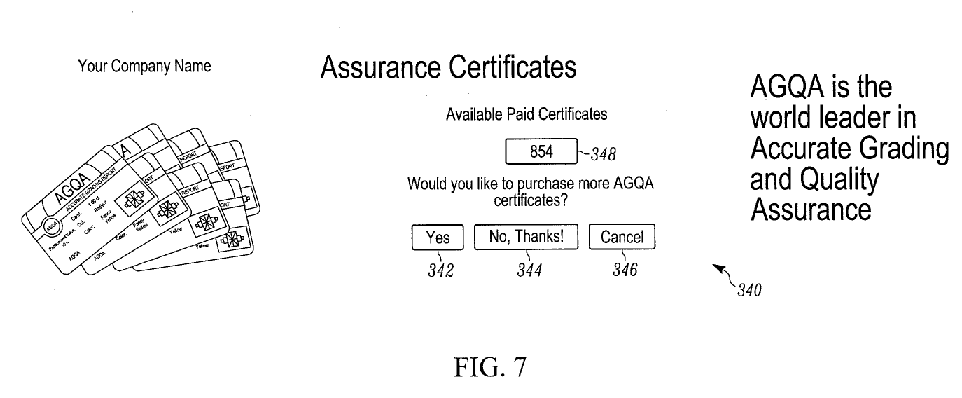

Turning to FIG. 7, upon logging into the system, a retailer is first presented with an opportunity to purchase certificates from the secondary company that the retailer in turn would present to customers when jewelry items are sold by the retailer to those customers. In a webpage 340 shown in FIG. 7, the retailer is provided with three buttons 342, 344 and 346, by which the retailer is allowed to indicate that the retailer would like to purchase more certificates, is not interested in purchasing more certificates, or would like to cancel the process, respectively. At a box 348, the webpage 340 also indicates the number of certificates that the retailer currently has purchased from the secondary company but has not yet issued to customers.

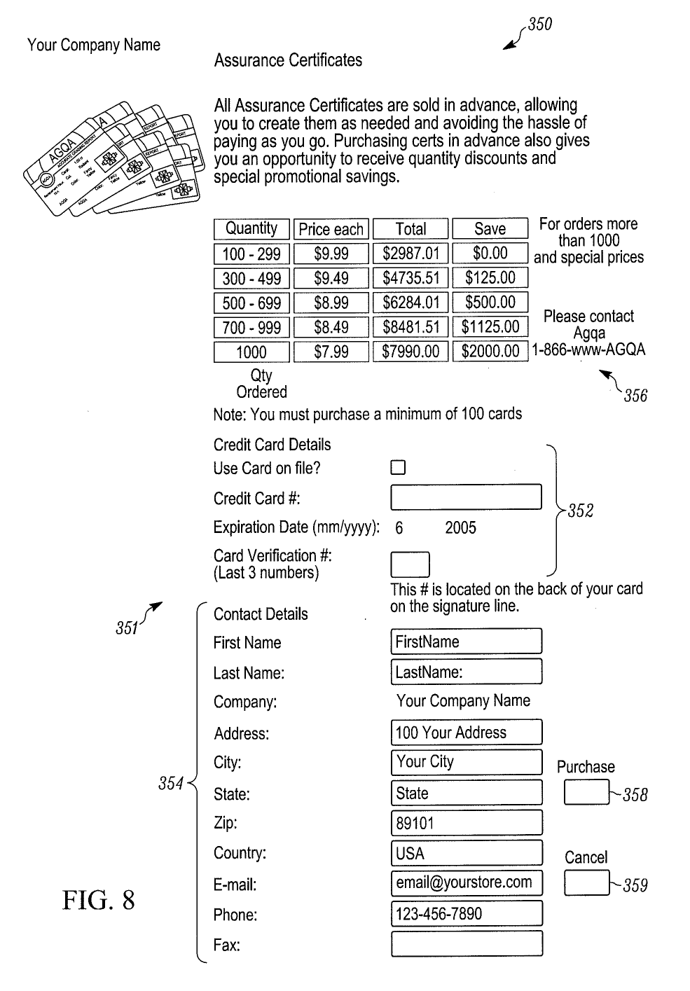

if the retailer indicates that it would like to purchase more certificates by pressing the button 342 of the webpage 340, an additional webpage 350 appears as shown in FIG. 8. The webpage 350 provides a form 351 that can be completed by the retailer allowing the retailer to purchase additional certificates. In the embodiment shown, the form 351 includes fields 352 to enter credit card information and additional fields 354 to enter contact information, as well as an area 356 in which pricing information regarding certificates is also shown. Upon entering the appropriate information, the retailer can select a purchase button 358 to purchase the indicated number of certificates or alternatively can cancel the transaction by pressing a cancel button 359.

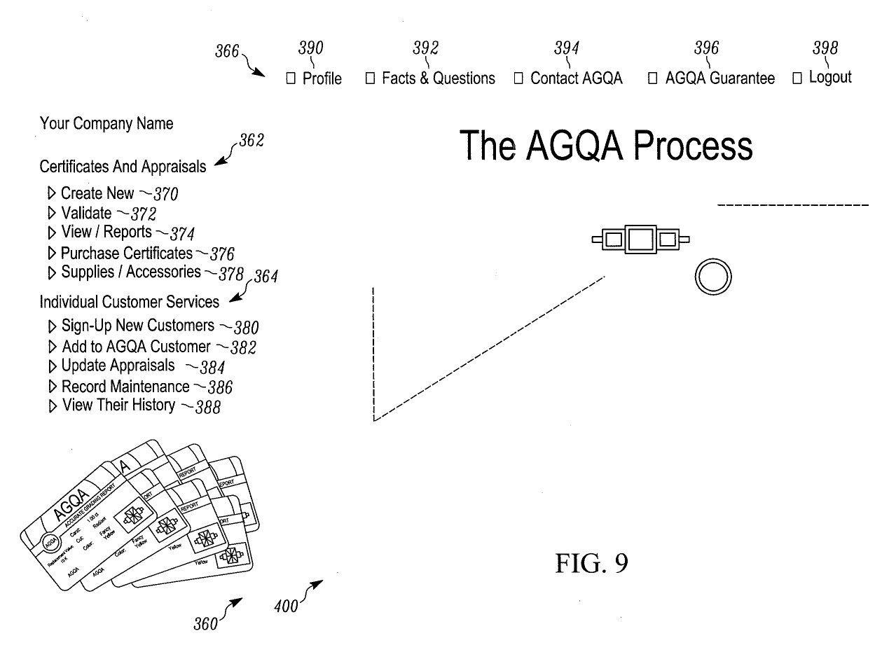

Once the retailer has purchased the new certificates or, alternatively, if at the webpage 340 the retailer indicates that the retailer does not desire to purchase any certificates at this time (e.g., by pressing one of the buttons 344 or 346), a new webpage 360 shown in FIG. 9 is displayed that offers the retailer various options. In particular, as shown in FIG. 9, the retailer is presented with a first set of options 362 concerning certificates and appraisals, a second set of options 364 concerning individual customer services, and a third set of options 366. The first set of options 362 includes a first option 370 in which the retailer can indicate that it wishes to create new certificates corresponding to new jewelry items 370, a second option 372 at which the retailer has an opportunity to validate a certificate, a third option 374 at which the retailer has an opportunity to view the status of multiple certificates that have been created and/or issued, a fourth option 376 at which the retailer can purchase more certificates, and a fifth option 378 at which the retailer can indicate a desire to purchase supplies and/or accessories associated with participation in the program.

With respect to the second set of options 364 concerning individual customer services, again the retailer is provided with five different options. A first option 380 is to sign up new customers, while a second option 382 involves adding information with respect to an existing customer. A third option 384 allows the retailer to update an appraisal, a fourth option 386 allows the retailer to record maintenance information concerning jewelry items, and a fifth option 388 allows for viewing of the history of various customers. As for the third set of options 366, these include a first option 390 to view a retailer profile, a second option 392 at which the retailer is presented with information regarding commonly asked questions concerning the program, a third option 394 in which the retailer is provided with contact information regarding the secondary company sponsoring the program (or, as discussed earlier, a screen allowing the retailer to create and send an e-mail message to the secondary company). A fourth option 396, upon selection, describes the guarantee/warranty (or possibly multiple types of guarantees/warranties) provided by the secondary company, and a fifth option 398 allows the retailer to log out of the system.

As shown in FIG. 9, the webpage 360 additionally has a central region 400 within which can be displayed a variety of information, as discussed further below with respect to subsequent FIGS. When the webpage 360 first appears in response to the logging in of a retailer, in the present embodiment, the central region 400 can display general information regarding the program such as information regarding the operation of the program (e.g., information corresponding to that shown in FIG. 5).

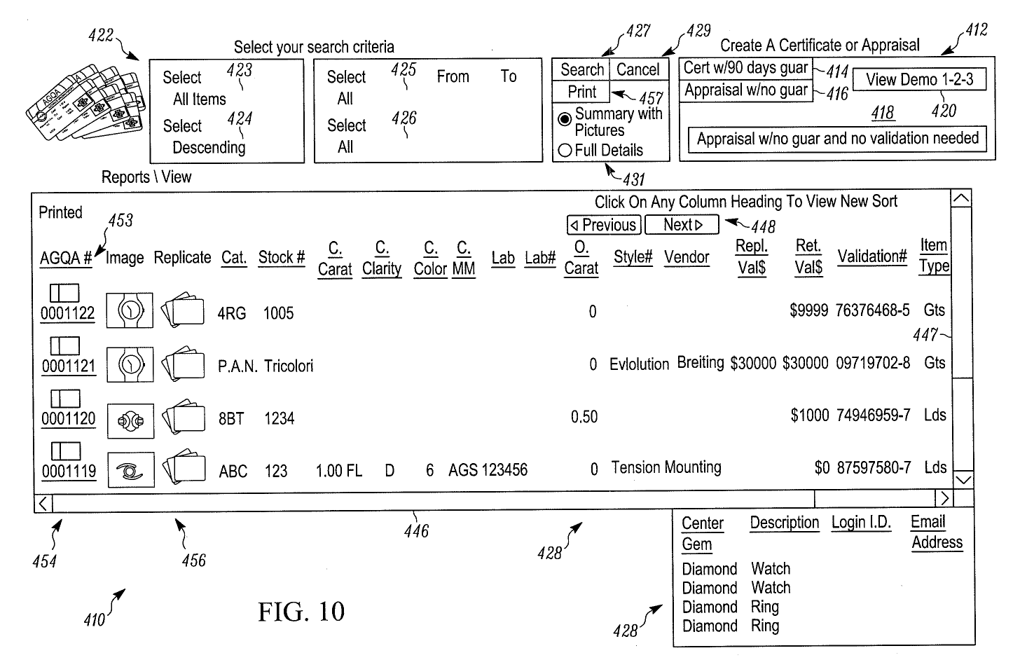

Upon the appearance of the webpage 360, the user has the ability to select any of the options shown 370-398. If the option 370 or the option 374 is selected, then a webpage 410 shown in FIG. 10 (or similar to that shown in FIG. 10) appears. As shown, the webpage 410 includes various buttons 412 in its upper right-hand corner allowing the user to create new certificates or appraisal documents. In particular, the buttons 412 include a first button 414 by which the retailer is able to create a new certificate with a 90 day guarantee, a second button 416 that allows the user to create an appraisal with no guarantee, a third button 418 that allows the retailer to create an appraisal with no guarantee (where no validation is needed), and a fourth button 420, upon the pressing of which the website then proceeds to show the three steps that are performed in creating a new certificate (particularly a new certificate with guarantee such as would result upon the pressing of the button 414). Although the buttons 412 in the present embodiment provide the four particular options shown, in alternate embodiments other options can also be provided. For example, a button could be provided that would allow a retailer to create a new certificate with any arbitrary number of days of guarantee.

Upon the pressing of the fourth “view demo 1-2-3” button 420, the system automatically provides successively first, second and third demonstration webpages 430, 440 and 450, respectively, as shown in FIGS. 11, 12 and 13, respectively. These webpages 430-450 demonstrate the typical steps that the user would progress through in order to create certificates with guarantees, that is, in the event that the button 414 were pressed. Similar (typically, fewer) steps would be followed in the event that other types of certificates or appraisal documents were created, for example, an appraisal with no guarantee.

Referring specifically to the webpage 430 shown in FIG. 11, typically the first step of creating a new certificate would involve specifying a certificate number (or other code) for the certificate in a field 432, which can be equipped with a drop-down menu or pick list feature allowing for the selection of a certificate number from multiple possible numbers. Next, at second and third fields 433 and 434, respectively, information regarding the jewelry item to be covered by the certificate is specified. In the example shown, the second field 433 is used to specify whether the jewelry item is for women or men, and the third field 434 allows for a description of the jewelry item to be selected (e.g., earrings, rings, bracelets, or necklaces).

Further, at a set of selection items 435, the user can then specify the color, or colors of (or, additionally, one or more designs of) the certificate being created. In a block 436, the user then further specifies a photograph to appear on the certificate (or possibly more than one photograph to appear on the certificate). Typically, the photograph that appears on a certificate will be selected by the user from one of a few photographs taken of the jewelry item that the certificate is intended to cover, e.g., photographs that were taken by the retailer of that jewelry item. Such photographs can be accessed by the user by pressing a button 437 within the block 436. In other circumstances, particularly when photographs of the jewelry item of interest are not available or are not likely to be suitable for display on the certificate, alternate, standardized photographs provided by the secondary company (or the retailer or even the customer) can be selected for display on the certificate by the user by pressing a button 438 within the block 436. As the selections are made by the user by way of completing the fields 432-434, choosing from selection items 435, and specifying photographs by way of the buttons 437 and 438, a visual image 439 of the certificate being created is also shown and updated.

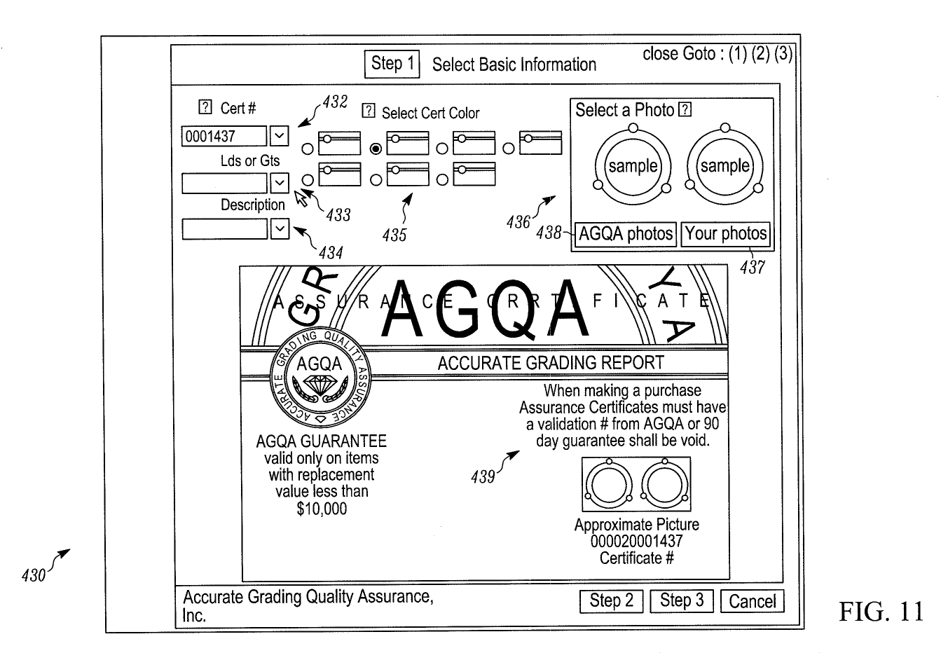

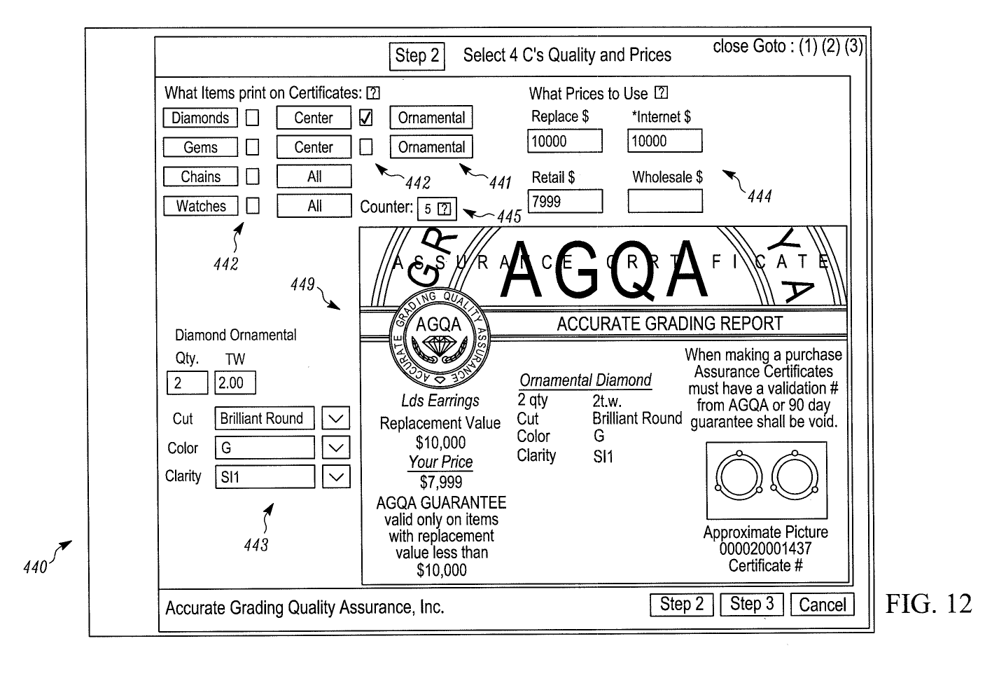

Once the operations associated with step one represented by the webpage 430 are completed, the process proceeds to step two with the display of the webpage 440 shown in FIG. 12. As shown, the webpage 440 provides the user with an opportunity to specify the specific diamonds or other attributes of the jewelry item in more detail. In an upper left-hand corner area 441, the user has an opportunity to indicate whether the jewelry item includes one or more diamonds, gems, chains and/or watches. In the case of diamonds and gems, the user further can indicate whether the diamond and/or gems on the jewelry item are center/primary or merely ornamental diamonds or gems. All of these indications regarding the characteristics of the jewelry items can be indicated by the user by checking one or more selection boxes 442.

Once the typology or characteristics of the jewelry item in question have been indicated, the user then provides further information regarding the particular items in a lower left-hand corner area 443. The types of fields located in the area 443 within which the user can indicate more detailed information can vary depending upon the embodiment. In the embodiment shown, when it has been indicated by the user that the jewelry item includes one or more ornamental diamonds as shown, then the area 443 provides fields that allow the user to specify the quantity of ornamental diamonds, the total weight in carats of the ornamental diamonds, the cut of the ornamental diamonds, their color and their clarity. As shown, in at least some of these cases, drop-down menus/pick lists are available to facilitate the information being provided by the user.

Once the detailed information has been entered into area 443, the user then additionally enters various price information at an upper right-hand corner area 444. In the embodiment shown, the price information that can be entered can include replacement value, retail value, internet value and wholesale value price information. Depending upon the embodiment, only some of these or several of these types of price information (or, additionally or alternatively, other types of price information) can be entered. Further as shown, it is possible for information concerning more than one jewelry item to be listed on the same certificate. When this is the case, a counter field 445 indicates the number of the jewelry item for which information is currently being specified (e.g., in the embodiment shown, the jewelry item is number 5). As with the webpage 430, the webpage 440 includes a visual image 449 that shows the certificate being created as various information is specified by the user.

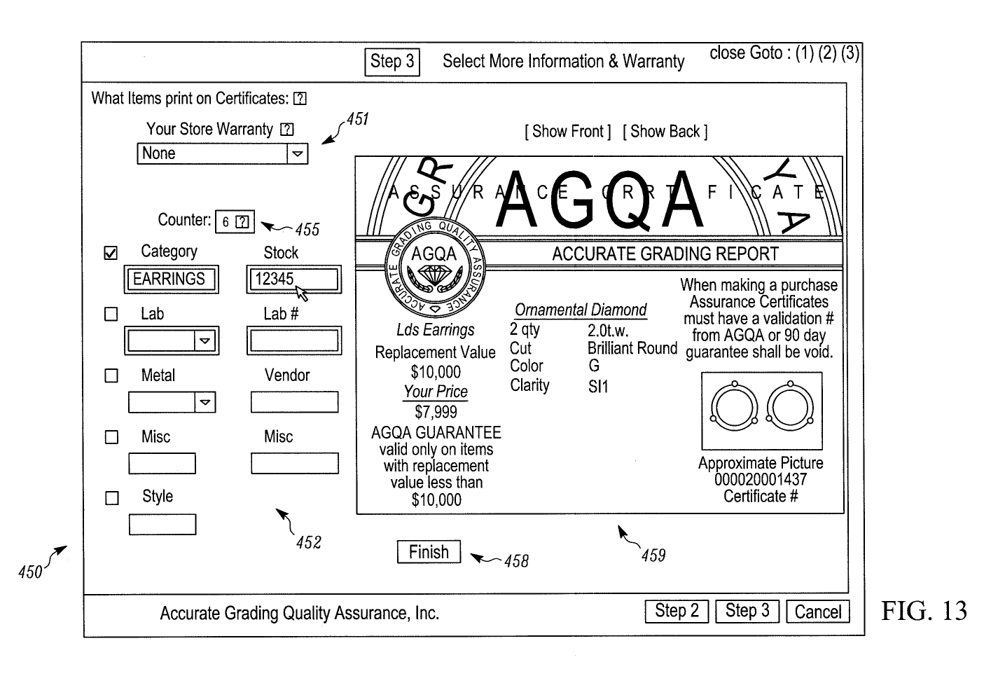

Referring to FIG. 13, the webpage 450 appears after completion of the information required by the webpage 440 during step 2, and requests additional information at a step 3. In particular, the user can enter into a field 451 whether the retailer is providing any warranty (e.g., a warranty above and beyond that provided by the secondary company) with respect to the purchased jewelry item. At multiple additional fields 452, the user also is provided with an opportunity to specify additional information regarding the jewelry item. Such additional information can include, for example, jewelry category and related stock number, an indication of whether the jewelry item was evaluated by a professional gemological laboratory and, if so, a corresponding lab name and number/code, a metal associated with the jewelry item (e.g., gold or silver), a vendor of the jewelry item, a style pertaining to the jewelry item and various other miscellaneous pieces of information. As before, a visual image 459 displayed on the webpage 450 continues to show the certificate as it is developed to include the further information provided by the user. Also, as in the case of the webpage 440, the webpage 450 provides a counter field 455 that allows the retailer to specify which jewelry item among several is currently being described by the entry of information by the user. Once all the information has been entered, the certificate creation process is completed, and the user can press a finish button 458 to end the process and return to either the webpage 410 or, alternatively, the webpage 360 (or possibly some other webpage).

Returning to FIG. 10, the webpage 410 not only allows for retail users to create new certificates or appraisal forms, but also allows the retailers to search for and select from among certificates that have already been created and possibly (although not necessarily) issued to customers in relation to the sales of jewelry items. In particular, the webpage 410 includes a search block 422 by which the user can specify search criteria and then commission a search of relevant certificates meeting the specified criteria. In the embodiment shown, a first portion 423 of the search block 422 provides a first field/pick list 423 at which the user is able to specify whether the certificates to be searched should pertain to jewelry items that have already been sold, that may have not yet been sold, that have been appraised, that have been printed or not printed, and/or items that have been or have not been registered (or, as shown, merely specify that all jewelry items are to be included within the search regardless of whether the jewelry items or their certificates fall into one of these classes or meet one or more of these criteria).

In a field 424, the user can further indicate whether the user wishes the results of the search to be displayed in a descending or ascending manner, typically based upon an alphabetical or numeric order. Further search criteria can be specified in fields 425 and 426. For example, the user can specify in the field 425 an indication of a desired category, a desired vendor, or a range of dates within which the jewelry item was sold. In the field 426, the user can specify search criteria relating to the characteristics of the jewelry item, for example, the carat weight, the clarity of the jewelry item, the color of the jewelry item, lab information, price information (e.g., any of the price information requested in webpage 440), stock number, style number, validation number and other criteria, as well as possibly date ranges for other ranges of such characteristics (e.g., a range of carat weights). The field 426 also allows the user to specify a requirement regarding certificate number/code.

Once the search criteria are specified by way of the fields 423-426 (or possibly other fields, or other mechanisms for receiving information from the user, not shown), the user can then request the search by pressing a search button 427. Typically, the search results are obtained by the system from one or more of the databases 140 at the central terminal 80, albeit other sources of data could also be consulted. Once the search results are obtained, the search results are displayed in a field or viewing area 428. If, during the search process commissioned by the pressing of the search button 427, the user wishes to cancel the execution of the search, the user can press a cancel button 429 within the search block 422 that causes the search to be aborted.

The reports generated by the search requests and displayed in the viewing area 428 can be displayed in a variety of manners and can include a variety of different information. To begin with, prior to commissioning the search by the pressing of the search button 427, the user can specify the extent of information to be displayed as search results by selecting one of two display options 431 listed in the search block 422, namely, a “summary with pictures” format and a “full details” format, where the former format would result in the display of less information than the latter format. In the embodiment shown, the retrieved information shown in the area 428 is provided in a tabular format, where different rows show information associated with different jewelry items or certificates, and different columns correspond to different types of information.

In the embodiment shown, the types of information associated with different columns can include each of the following, if not additional types of information: certificate number, reduced-size image, category type, stock number, carat weight, clarity, color, mm, laboratory name, laboratory number, overall carat weight, style number, vendor name, replacement value, retail value, validation number, item type, center gem type, other jewelry description, log on I.D., and email address information, among others.

Because the number of columns required to display the various types of information is often so large that the table cannot fit within the viewing area 428, the viewing area in the present embodiment includes a horizontal selection bar 446 that allows the user to shift the horizontal positioning of the table relative to the viewing area or window. For convenience, FIG. 10 shows the exemplary table to be broken up into two sections so as to make evident all of the columns of the table, although it should be understood that not all columns of the table are typically visible to a user simultaneously. Likewise, because the number of jewelry items or certificates identified in a given search often will exceed the size of the viewing area 428, a vertical selection bar 447 also typically is provided to allow for the user to scroll through the various rows of the table. To the extent that the table has a number of rows that exceeds a given number (e.g., 20 rows), the table can further be broken up into subtables, and the user can move among the different subtables by clicking on previous and next buttons 448.

In addition to making available to a user a great deal of information regarding different jewelry items and certificates, the manner in which the information is presented in the tabular format in the viewing area 428 makes it possible for the user to reshuffle or reorder the search results in a variety of ways. For example, the user can click on each of the headings 453 of the different columns to reorder the search results according to the characteristics associated with that column heading. Thus, while in FIG. 10 the jewelry items are ordered according to their certificate numbers, by clicking on the heading associated with the carat weight characteristic, the user could reorder the results according to carat weight. Also, by clicking on a given certificate number (e.g., by clicking on a certificate number as displayed within the first column 454 of the table displayed in FIG. 10), the user can cause to be displayed an image of that certificate.

Further, in the embodiment shown, the table includes a third column labeled “replicate,” This column typically is only available when the webpage 410 appears as a result of the user indicating that a new certificate is to be created (e.g., as a result of the selection of the option 370 in FIG. 9), but not when the user merely indicates the desire to search for results and view reports (e.g., as indicated by selection of the option 374 in FIG. 9). The replicate feature allows the retailer to rapidly create certificates that are identical (or at least similar) to existing, previously-created certificates. That is, by clicking on a replicate icon associated with a given certificate displayed within the table of the viewing area 428, the user can automatically commission the creation of an additional certificate identical to (or similar to) the certificate associated with that role. Further as shown in FIG. 10, upon the display of search results in the form of a table such as that shown in the viewing area 428, the results can be printed by the user upon selection by the user of a print button 457. Upon completion of the need to create new certificates or perform or review search results, the user can return to the webpage 360 of FIG. 9 by pressing the cancel button 429.

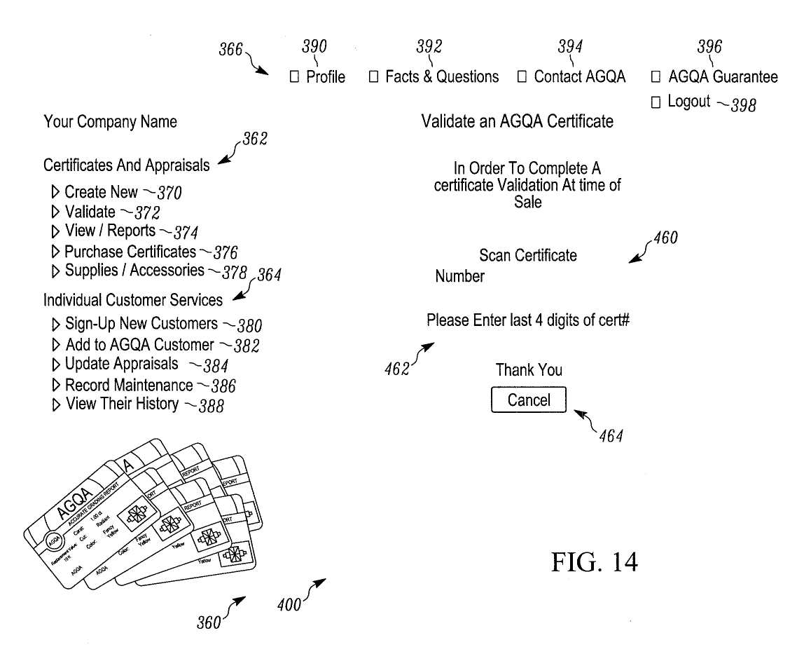

The webpages shown in FIGS. 10-13 appear in response to the selection by the user of options 370 and 374 shown in FIG. 9. However, the selection of the other options 372, 376, 378 and 380-398 each cause additional webpages to be displayed or, alternatively, cause different information to appear within the region 400 of the webpage 360. For example, as shown in FIG. 14, when the user selects the validate option 372 in order to validate a certificate that has just been issued to a customer in relation to a purchased jewelry item, the webpage 360 becomes modified such that the region 400 displays several fields 460, 462 and 464 to achieve a validation process. More particularly, in the embodiment shown, a certificate number needs to be provided by the retailer, in the field 460 (in alternate embodiments, a validation number would also be required). In a particularly preferred embodiment, the certificate number is provided merely by scanning the bar code on the certificate being validated by way of the bar code reader (discussed above). The retailer then confirms that the proper number was scanned in by entering the last four digits of the certificate number in the field 462. Once the certificate number information has been provided, validation is complete. The validation process can be canceled by the user by selecting a cancel button 464.

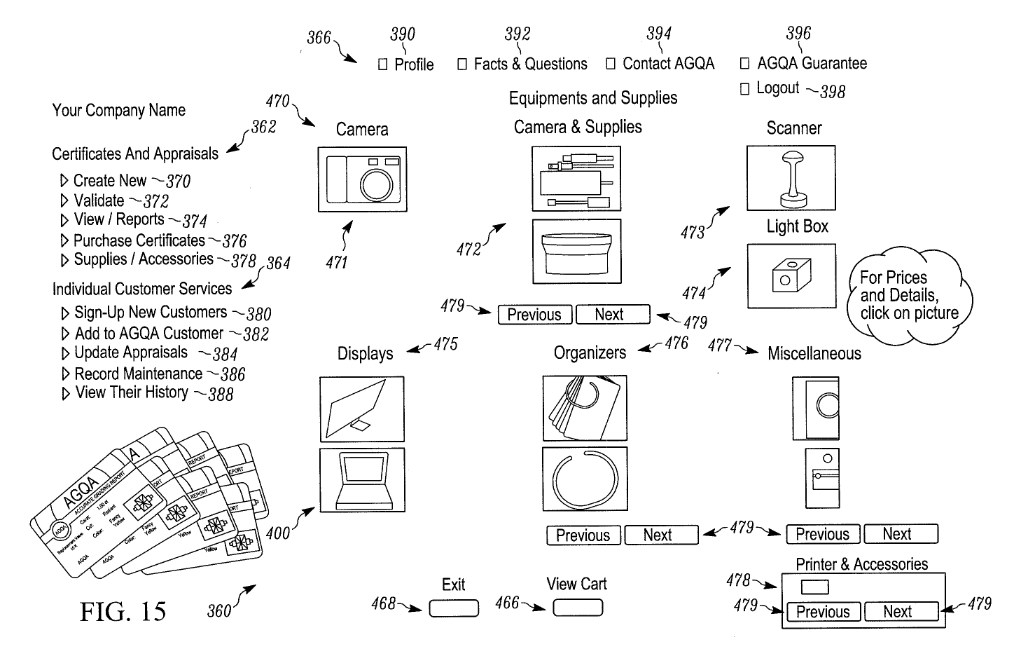

If the purchase certificates option 376 is selected by the user, the webpage 360 reverts to the webpage 350 discussed above with respect to FIG. 8, by which the user can purchase additional certificates. Further, if the user selects the option 378 corresponding to supplies/accessories, the webpage 360 becomes modified as shown in FIG. 15, such that the central region 400 is modified to display various equipment and supplies that the retailer can purchase from the secondary company. In the embodiment shown, the equipment and supply information that is displayed as information 470 includes camera information 471, camera supply information 472, bar code scanner information 473, light box information 474, display information 475, organizer information 476, printer and accessories information 478, and information regarding other miscellaneous items 477. With respect to some of these categories of information, previous/next buttons 479 are also shown that allow the user to select from among a variety of different options within that category.

Also as indicated by FIG. 15, additional price information and other details regarding the various products can be obtained by clicking on the thumbnail image that is shown. For example, a description of a particular light box 474 would be provided upon clicking on the image for that light box, e.g., information explaining how the light box works (e.g., serving as a box within which a jewelry item can be positioned in a manner allowing for the taking of consistent pictures of that jewelry item). Items can be selected for purchase also by clicking on the images associated with the respective items. In particular, when the information associated with a given item is provided in response to clicking on the image associated with that item, a further button (not shown) is displayed allowing the user to specify that the item should be added to a shopping cart.

Once the user has selected one or more items (from any one or more of the different categories of items), the user can also view all of the contents of the user's shopping cart by pressing a view cart button 466. When the view cart button 466 is pressed, the retailer then is provided with an opportunity to complete the purchase of those items. Typically this will include the presentation to the user of a credit card form to be filled out by the user, followed by a command to execute the transaction, although in some embodiments the retailer can have a pre-established relationship with the secondary company such that such credit card information need not be provided each time items are purchased. Once the user has completed purchasing those items that are desired, or decided not to purchase any items, the user can return to the version of the webpage 360 showing FIG. 9 by pressing an exit button 468.

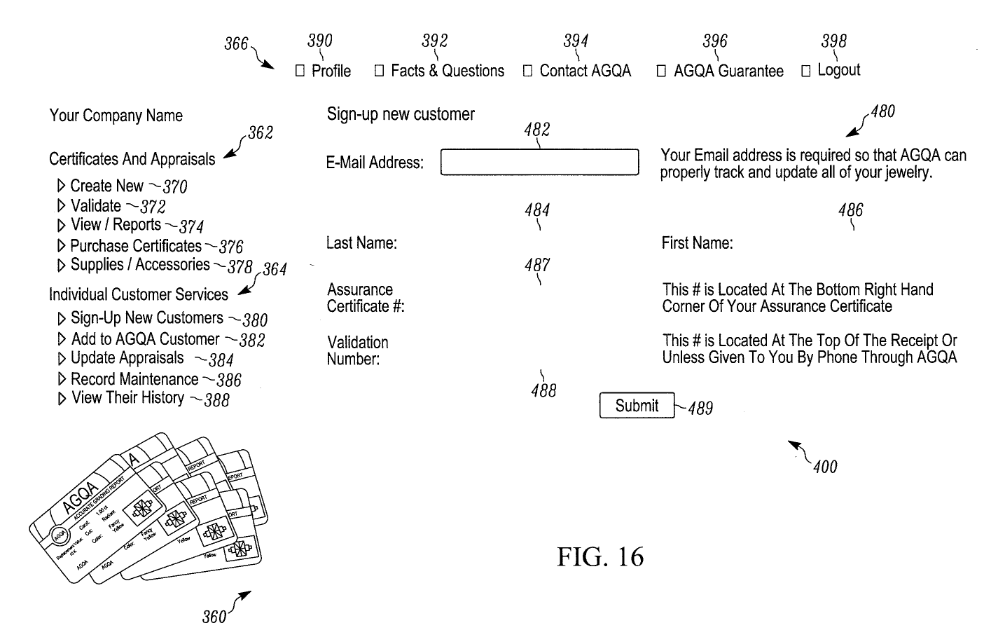

Turning to FIG. 16, the webpage 360 takes on yet another form upon the selection of the sign-up new customers option 380. In this case, a sign-up new customers window 480 appears that provides fields 482, 484, 486, 487 and 488 in which the retail user can specify the email address of the new customer, the last name of the new customer, the first name of the new customer, a certificate number of the new customer and a validation number/code corresponding to the new customer/purchased jewelry item, respectively. As discussed further below, in certain embodiments, new customers can sign themselves up independently of retailer assistance. However, in the present embodiment, retailers also are capable of signing up the new customers when the customers purchase new certificates associated with the purchasing of new jewelry items, or assisting customers who wish to sign up some time after the purchases of their jewelry items. Indeed, it is also possible for different retailers to sign up customers than those who sold the customers their jewelry, assuming that the retailers conducting the signing-up of the customers are members of the program sponsored by the secondary company. When the information concerning a new customer has been entered by the retailer, the retailer can submit this information by pressing a submit button 489, resulting in the signing-up/registration of that customer and the returning of the webpage 360 to the form shown in FIG. 9.

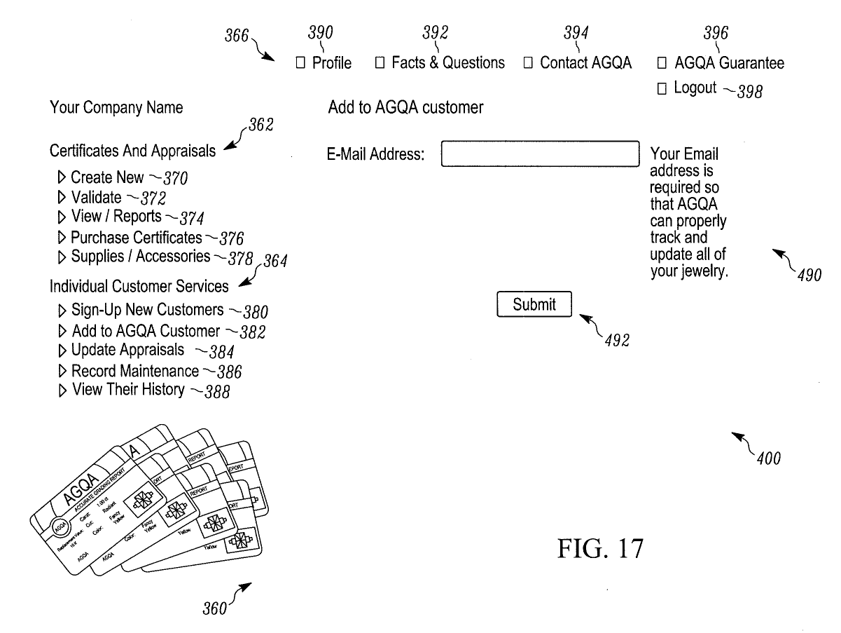

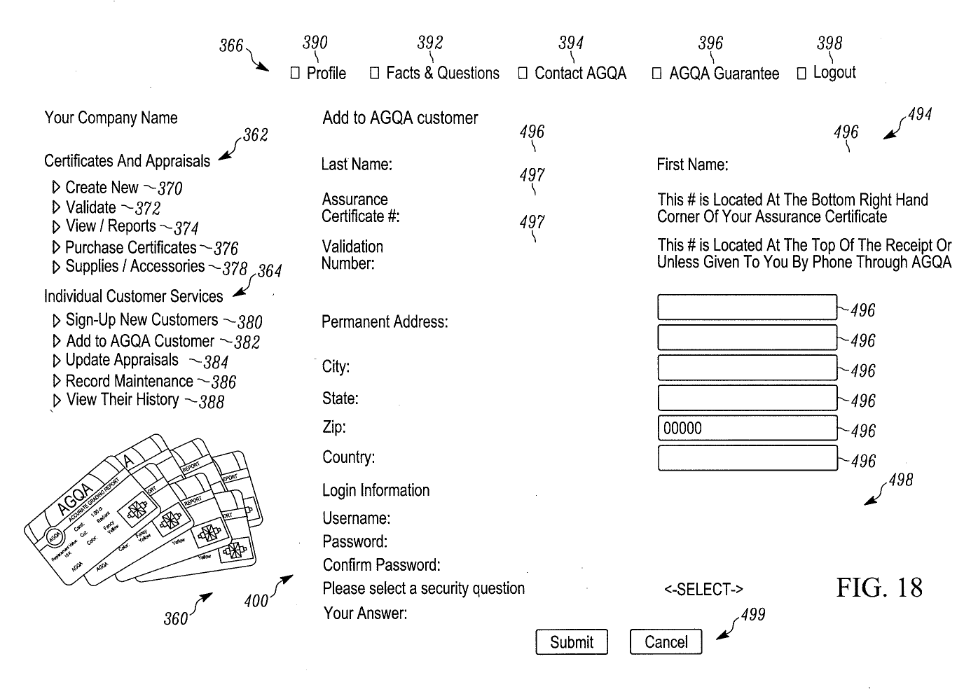

Turning to FIG. 17, the website also provides the retail user with an opportunity to add new customers to the program being sponsored by the secondary company. Typically this occurs when a customer has for the first time purchased a jewelry item that is the subject of a certificate, either at the very time when the purchase is made or at a later time when the customer visits the retailer for some other reason. In particular, when the retailer has an occasion to add a new customer, the retailer selects the add-to customer option 382 of the webpage 360. When that occurs, the central region 400 of the webpage 360 changes to that shown in FIG. 17 so as to display a first field 490 in which the retailer enters an email address from the customer (which is provided to the retailer by the customer upon inquiry). Once the email address is entered, the retailer presses a submit button 492, which results in additional information and entry fields being displayed within the central region 400 as shown in FIG. 18.

More particularly, as shown in FIG. 18, a window 494 appears by which the retail user is provided with multiple fields 496 into which the user enters various information about the customer including, for example, the customer's last name, the customer's first name, and the customer's permanent address. As mentioned above, a new customer is typically added only after a jewelry item covered by a certificate is purchased by the customer. When such a transaction occurs, the customer not only has a certificate number/code as stated on the issued certificate, but also has a validation number/code, which typically is displayed either on a receipt associated with the transaction or possibly is provided to the customer in some other manner, for example, by the secondary company. The certificate number and validation number are entered by the retailer into appropriate fields 497.

In certain embodiments, the certificate number (and/or, in alternate embodiments, the validation number) can also be entered by the retail user by bar code scanning a bar code on the certificate issued to the customer. Through the entry of both a certificate number and a validation number, the system is able to further verify the accuracy and validity of the certificate. In addition to the above-described information, the retailer also enters log in information such as a customer-specified user name and password (and security questions and related answer) into fields 498, such that at a later time the customer himself or herself can access information from the system as described in further detail below. Once all of this information is entered, the retail user can complete the addition of the new customer or, alternatively, cancel the transaction by selecting the appropriate one of a pair of buttons 499.

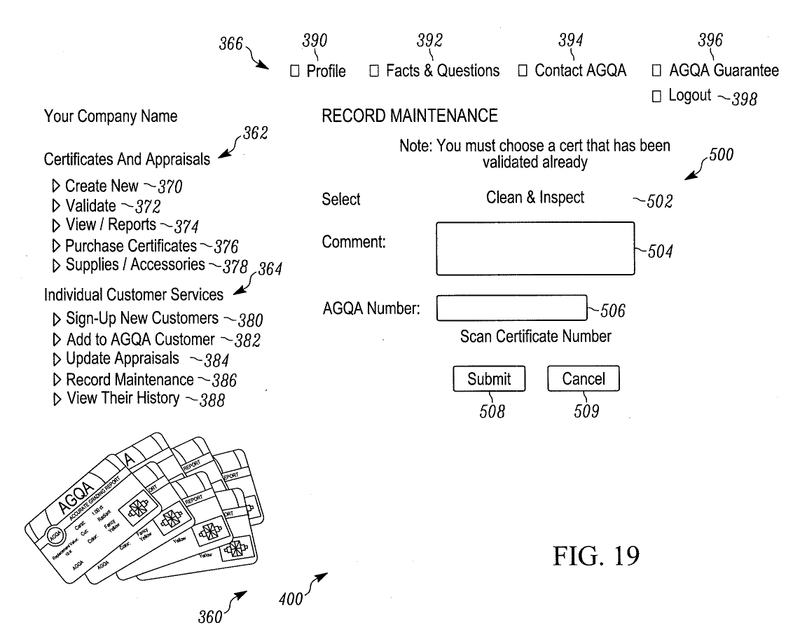

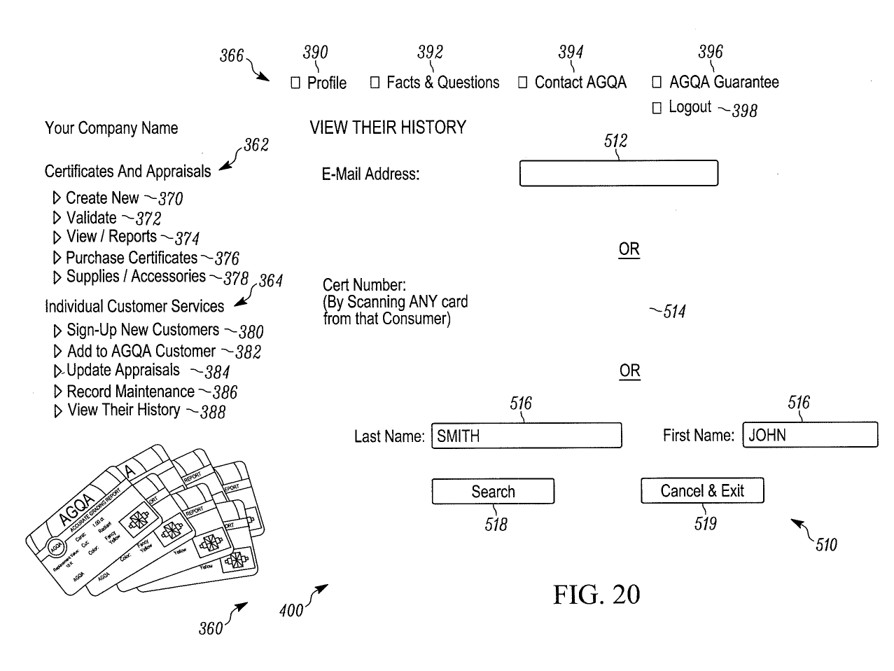

Turning to FIGS. 19 and 20, the central region 400 of the webpage 360 can also display additional types of information depending upon whether the retail user selects the “update appraisals” option 384, the “record maintenance” option 386 or the “view history” option 388. Although not shown, selection of the “update appraisals” option 384 would result in fields by which case the retail user would be provided with an opportunity to enter a certificate number and then, upon doing so, would be provided with the opportunity to enter/change appraisal information related to the certificate. Typically, as discussed above, a customer requesting an appraisal would provide the retail user with the customer's certificate, and retail user would scan in the certificate number/code using the bar code scanner. Then, upon completion of the appraisal, the new appraisal information would be entered and saved on the system.

As shown specifically in FIG. 19, when the “record maintenance” option 386 is selected, a form 500 is displayed within the central region 400 allowing the retailer to input various information concerning the maintenance history of a jewelry item. In particular, the retailer is provided with a pick list 502 from which the retailer is able to select a particular type of maintenance function and then, in a field 504, the retailer is able to provide additional comments regarding the maintenance function or history pertaining to the jewelry item. The jewelry item to which the maintenance information pertains is specified when the retailer enters the certificate number corresponding to that jewelry item in a field 506. The entry of this information again can be accomplished manually or by scanning the bar code on the certificate pertaining to the jewelry item.

Once the maintenance information has been inserted, the retailer can store that information as part of the record pertaining to that jewelry item by pressing a submit button 508, or cancel the transaction by pressing a cancel button 509. By entering this maintenance information, a historical maintenance record can be easily maintained in connection with the jewelry item. Further, this maintenance history feature allows a customer to take his or her jewelry item to many different retailers and still have the maintenance history recorded. Because a customer can bring his or her jewelry item and corresponding certificate to any one of a number of different retailers that are involved in the program sponsored by the secondary company, the maintenance history information allows for such multiple different retailers to understand the maintenance history of the jewelry item. Thus, the jewelry item need not always be brought to the retailer who sold the jewelry item or any particular retailer for maintenance.

As for FIG. 20, upon the selection of the “view their history” option 388, a form 510 is provided in which the retail user is able to bring up information regarding any of its customers (and even possibly those of other retailers). To identify a particular customer, the user enters any one of a number of identifiers of a particular customer, jewelry item, and/or certificate, in particular, the form 510 allows a customer or jewelry item/certificate to be identified either by specifying a customer email address in a field 512, a certificate number in a field 514, or a customer name in fields 516. As previously discussed, the certificate number can be manually entered by the retail user or by way of scanning the bar code appearing on a certificate presented by the customer. Once appropriate identification information has been obtained, the retailer can proceed with a search for records by pressing a search button 518 or, alternatively, can cancel the transaction by pressing a cancel and exit button 519.

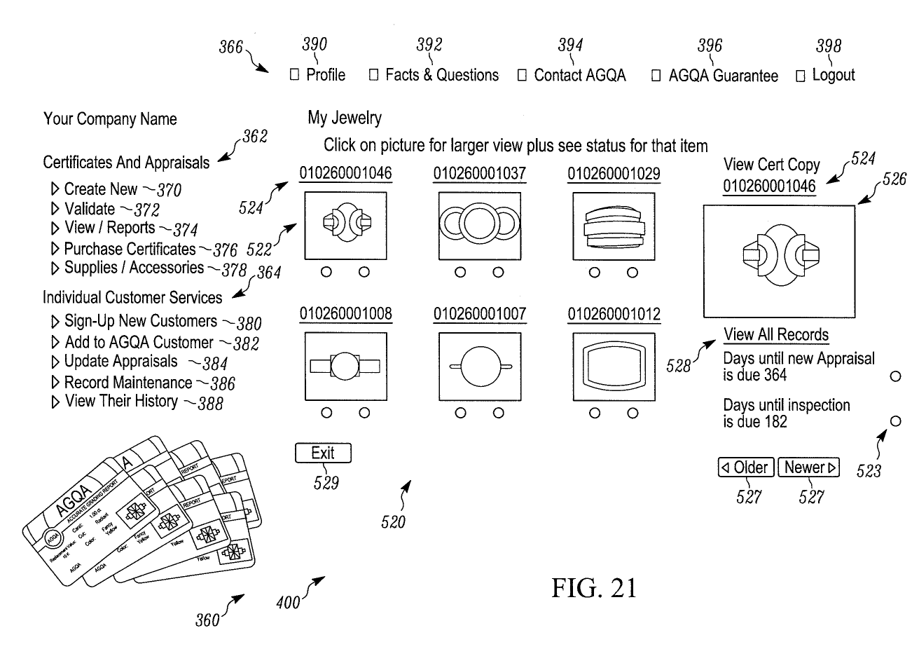

If the search for records corresponding to the customer/certificate/jewelry item results in appropriate records, the website then displays such search results 520 in the central region 400 of the webpage 360 as shown in FIG. 21. In the example shown, a search was conducted (see FIG. 20) for a customer John Smith, and FIG. 21 shows that the system contains numerous records of jewelry items that correspond to that customer. In particular, six of the items are shown at one time, both in terms of their corresponding certificate numbers 524 and by way of thumbnail images 522 of the jewelry items. The retailer, by clicking on any one of the particular pictures or certificate numbers is able to bring up a larger image 526 of that jewelry item along with the certificate number and additional information 523 corresponding to that jewelry item and its corresponding certificate. Such additional information 523 can include maintenance history information, appraisal information, and also (particularly as shown) estimates as to the amount of time or days until a new appraisal for the jewelry item should be performed or a new inspection for the jewelry should be performed.

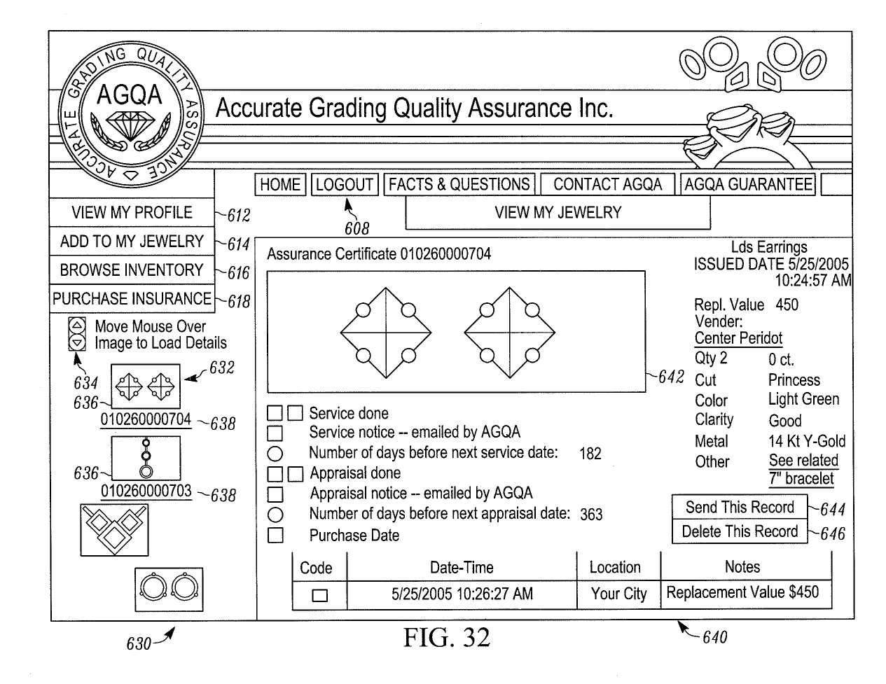

By selecting (e.g., clicking on) the certificate numbers 524, an image of the certificate corresponding to the jewelry item can be displayed. Further, by pressing a view all records button 528, additional information regarding the jewelry item of interest can be displayed (see FIG. 32 regarding exemplary information that can be displayed). As in the present case, where more than six jewelry items have been identified in the search, the retail user can also scroll among the search results to view different ones of the search results by way of buttons 527. Also, the retailer can exit the search results information and end this transaction by pressing an exit button 529.

Referring again to FIG. 9, while the retail user can access each of the options associated with the sets of options 362 and 364 as discussed above, the retailer also has several other options available in connection with the set of options 366. In particular, by selecting options 392, 394, 396 or 398, respectively, the retailer can obtain information related to the certification program being sponsored by the secondary company, obtain contact information regarding the secondary company, obtain information regarding the guarantee/warranty or guarantees/warranties provided by the secondary company in relation to the certificates or otherwise, and can log out of the website, respectively. Additionally, by selecting the “profile” option 390, the retailer can obtain information that has been stored in the system regarding its own identity and, in at least some embodiments, is able to update or modify that information.

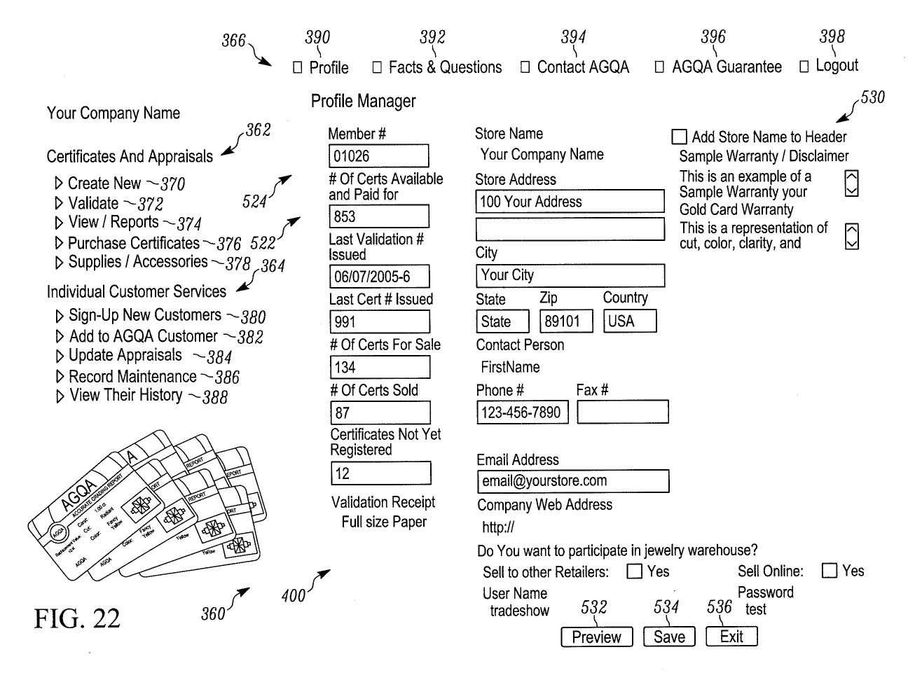

FIG. 22 in particular shows that profile manager information 530 is displayed within the central region 400 of the webpage 360 when the “profile” option 390 is selected by the retail user. Although not shown, typically the profile manager information only can be obtained after the retailer has specified its password. As shown in FIG. 22, in at least one embodiment, the profile manager information 530 is displayed in a form having multiple fields, and includes a variety of information including member number information, retail store name, address and contact (including phone and email) information regarding the retail store, and information regarding the number of certificates that have been purchased by the retailer from the secondary company in conjunction with the program, as well as information regarding the history of usage and issuance of those certificates. Sample or exemplary warranty information also can be provided.

By pressing a preview button 532, the information is displayed for the user in a printable format that summarizing all the information that the retailer has entered. In certain embodiments, the retailer is also presented with opportunities to specify other information including its user name, password, and whether it wishes to participate in jewelry warehouse events or sell to other retailers or sell on-line. Once the retailer has properly entered, updated or modified its information, the retailer can save the information by pressing a button 534 and exit the system by pressing an exit button 536. As noted above, the retailer can fully exit the website at any time by selecting the log out button 398.

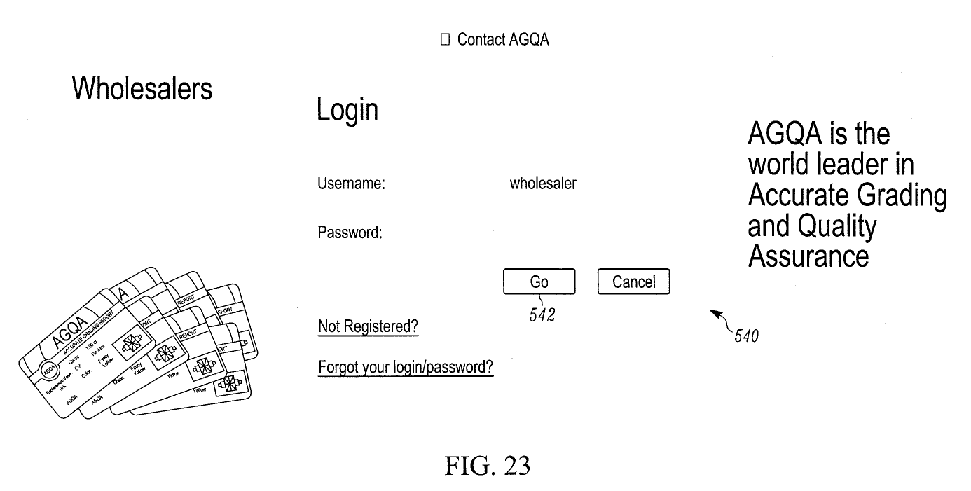

In the present embodiment, the website is accessible not only by retailers but also by wholesalers and consumers. FIG. 23 shows a log in webpage 540 that can be brought up by someone wishing to enter the system as a wholesaler by appropriately attempting to log in from the webpage shown on FIG. 4. The log in webpage 540 for wholesalers (e.g., users affiliated with wholesalers) requires a wholesaler to enter a username and a password. Upon the entry and submission of this information, by the pressing of a go button 542, the website provides a number of webpages that are similar albeit not identical to those discussed above with respect to retail users interacting with the website.

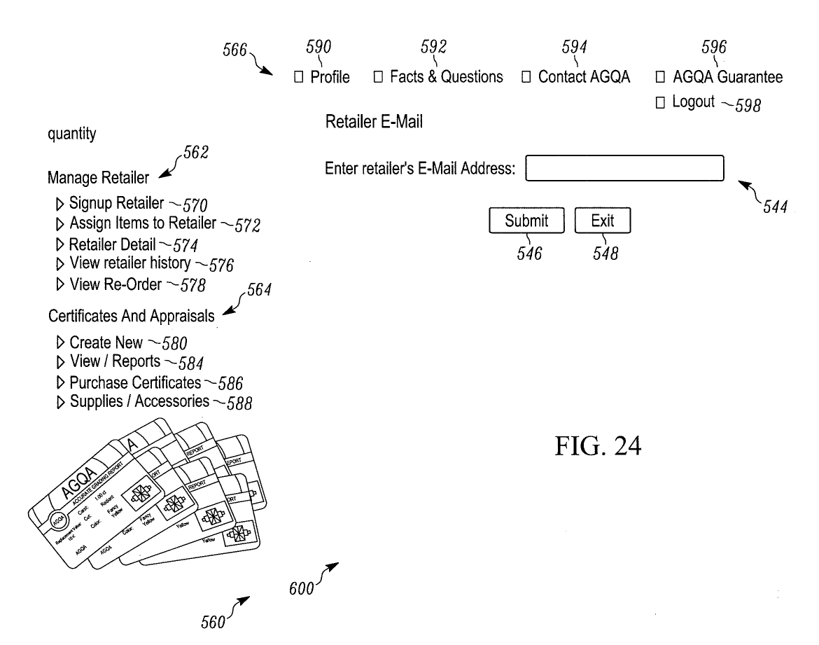

Although not shown, upon first logging into the system, the wholesaler is presented with an opportunity to purchase additional certificates as discussed above with reference to FIGS. 7 and 8. Once the wholesaler has either purchased new certificates or bypassed the purchasing process, a webpage 560 appears as shown in FIG. 24. The webpage 560 is similar to the webpage 360 shown in FIG. 9 insofar as it includes a central region 600 within which a variety of information can be displayed (when first initially appearing, information rewarding the program can be displayed as was the case in FIG. 9). Additionally, the webpage 560 provides the wholesaler with a first set of options 562 concerning the managing of retailers, a second set of options 564 concerning certificates and appraisals, and a third set of options 566. The manage retailer options 562 include a first “sign-up retailer” option 570, a second “assign items to retailer” option 572, a third “retailer detail” option 574, a fourth “view retailer history” option 576 and a fifth “view re-order” option 578. The second set of options 564 includes a first “create new” option 580, a second “view/reports” option 584, a third “purchase certificates” option 586, and a fourth “supplies/accessories” option 588. The third set of options 566 includes a first “profile” option 590, a second “facts and questions” option 592, a third “contact” option 594, a fourth “guarantee” option 596 and a fifth “logout” option 598.

The options 570-598 available to the wholesaler when accessing the system bear significant similarities to those available to retailers as discussed above. In particular, the options 590-598 serve the same purposes as the corresponding options 390-398 discussed above, except insofar as the profile option 590 allows for the entry and modification of profile information concerning a wholesaler rather than a retailer as was the case with the option 390. The options 580, 584, 586 and 588 available for selection by the wholesaler also result in similar or identical behavior by the website as was discussed above in relation to options 370, 374, 376 and 378, respectively.

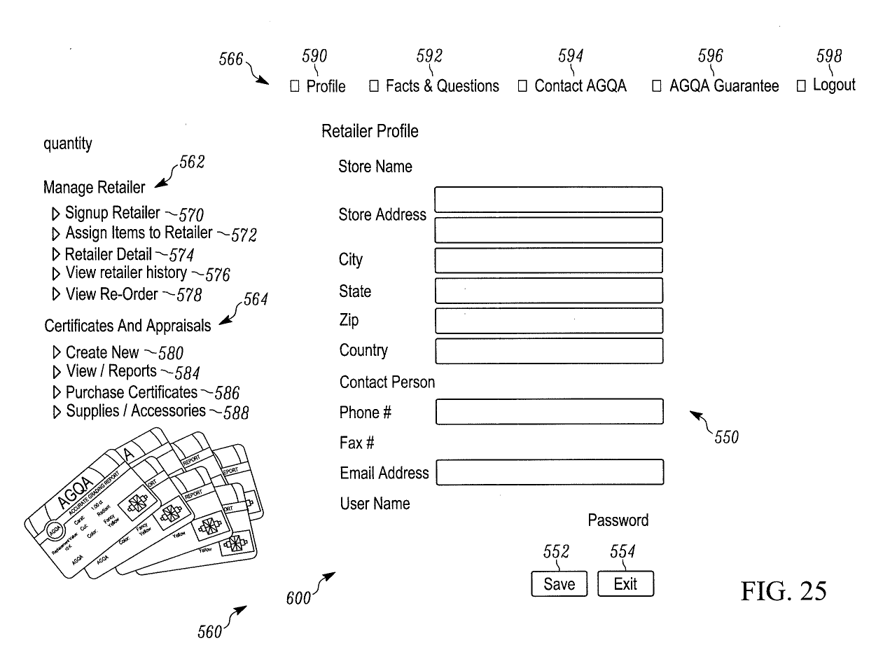

The first set of options 562 available to the wholesaler are advantageous in that they allow a wholesaler to enroll retailers with whom the wholesaler is dealing into the program sponsored by the secondary company that is guaranteeing the certificates and hosting the website. These options further allow the wholesaler to observe and monitor retailer participation in the program. In particular, as shown in HG. 24, the first “sign-up retailer” option 570 upon being selected by a wholesaler results in the display of a field 544 in which the wholesaler can enter a retailer's email address. Upon submission of that information by the pressing of an appropriate submit button 546, the wholesaler is provided with a form 550 as shown in FIG. 25. The wholesaler can then enter a variety of information including retailer name and contact information into the form 550 and subsequently save the information by pressing a save button 552, after which the wholesaler user would subsequently exit the signing-up process by pressing an exit button 554.

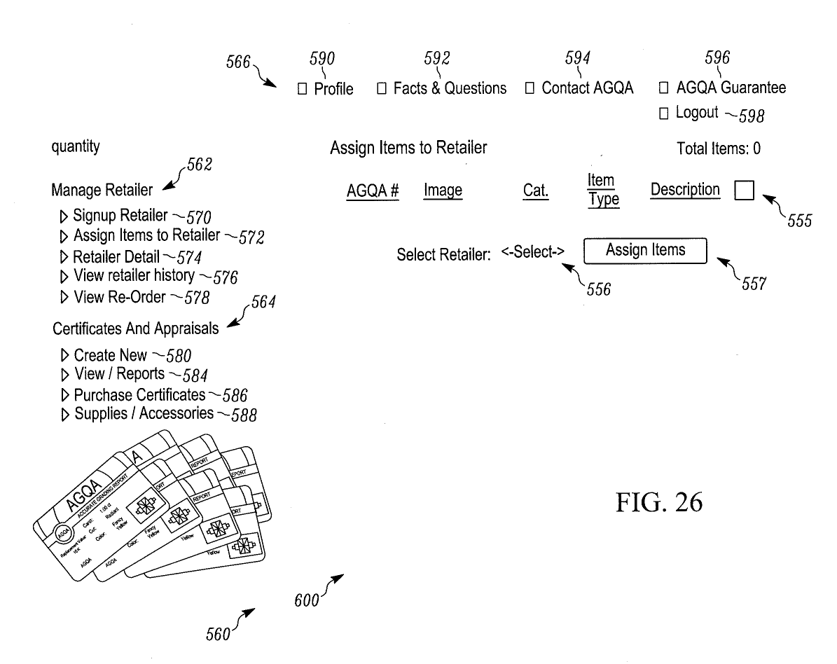

FIGS. 26-29 respectively show fields that appear within the central region 600 of the webpage 560 in response to a wholesaler's selection of the options 572, 574, 576 and 578, respectively. In particular, as shown in FIG. 26, when the second “assign items to retailer” option 572 is pressed, the wholesaler is presented with a list 555 of certificate numbers/jewelry items that can be assigned to different retailers and also with a field or pick list 556 by which the various items can be assigned to a particular retailer or retailers. Although the list 555 shown in FIG. 26 does not list any items, it should be understood that when a list of items is presented, the wholesaler can highlight one or more of those items that are listed and then specify that those items are to be assigned to the specified retailer. Once the particular retailer is selected by way of the field/pick list 556, the wholesaler can assign those items by pressing an assign items button 557.

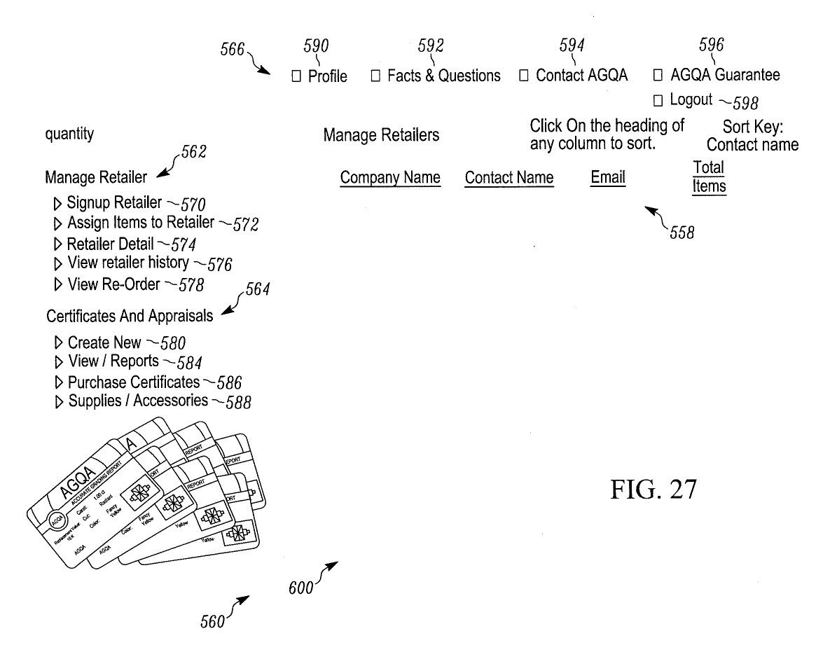

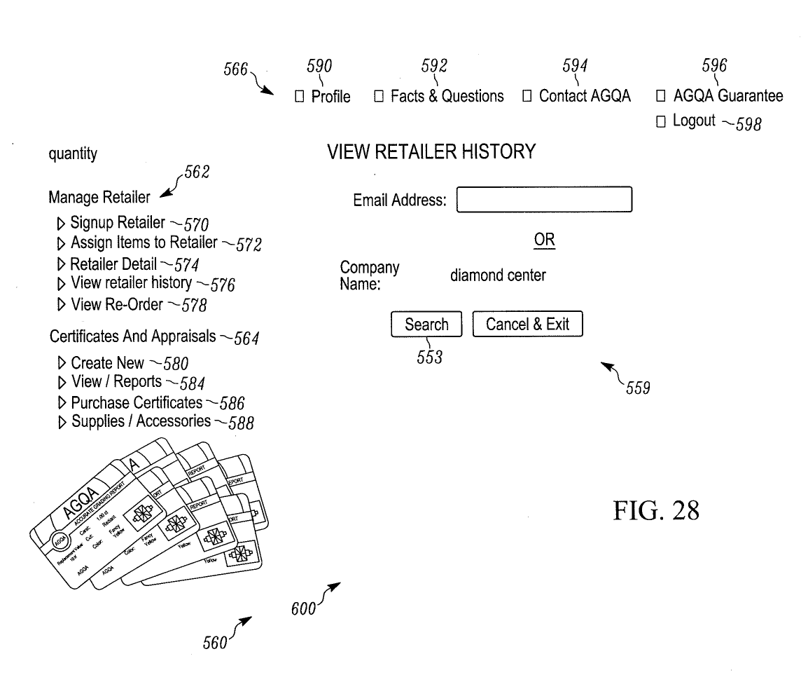

With respect to FIG. 27, when the wholesaler selects the third “retailer detail” option 574, a listing 558 of various retailers, their respective contact and email information and the total number of items (e.g., jewelry items having corresponding certificates) associated with those retailers is shown. The order of the listing can be varied in a number of ways depending upon which of the headings is selected. Further as shown with respect to FIG. 28, when the fourth “view retailer history” option 576 is selected, the wholesaler is provided with a window 559 in which the wholesaler is able to enter an email address or company name identifying a retailer of interest and then capable of searching for relevant records pertaining to that retailer by pressing a search button 553. The search results are presented in much the same was as the information is presented in FIG. 21. Finally, when the fifth “view re-order” option 578 is pressed, a list 551 appears within the central region 600 listing a number of certificates/jewelry items that can be reordered from the wholesaler.

Turning to FIGS. 30-34, in the present embodiment the website is also accessible by customers who have purchased jewelry items covered by one or more certificates guaranteed by the secondary company. As already discussed above, FIG. 30 shows the webpage 330 that allows a customer to log in to the website. As discussed above, when a customer accesses the website for the first time, the customer needs to enter a certificate number and a validation number into fields 332 and 334, respectively, and submit that information by pressing the submit button 336 to enter the website. However, if the customer is already a registered member, the customer can enter the website simply by entering the customer's user name and password into respective fields 331 and 333, respectively, and then pressing the submit button 336. The customer can become a registered or current member simply by way of the process discussed above in relation to FIG. 16, in which a retailer signs up a new customer. To the extent that a customer is logging into the website for the first time by completing the fields 332 and 334, upon submission of this information the customer can be presented with another form in which the customer enters various information that is of interest including, for example, contact information (not shown).

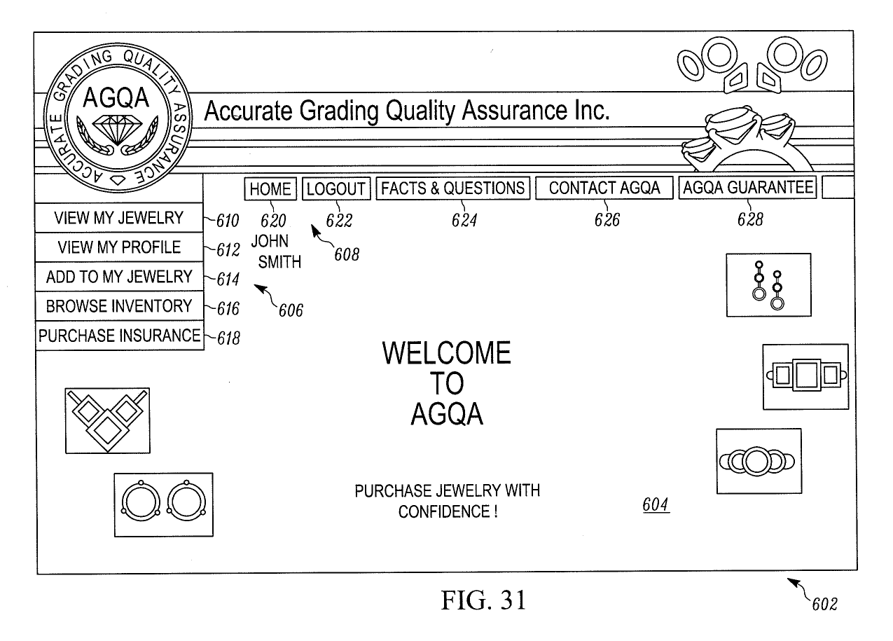

Once the customer has logged into the website, the customer will be presented with a welcoming webpage 602 shown in FIG. 31. The welcoming webpage 602 includes a central region 604 that displays a welcoming message to the customer who has logged into the website. In addition, the webpage 602 includes a first set of options 606 and a second set of options 608 that are selectable by the user. More particularly, the first set of options 606 includes a first “view my jewelry” option 610, a second “view my profile” option 612, a third “add to my jewelry” option 614, a fourth “browse inventory” option 616 and a fifth “purchase insurance” option 618. Additionally, the second set of options 608 includes a first “home” option 620, a second “log out” option 622, a third “facts and questions” option 624, a fourth “contact” option 626, and a fifth “guarantee” option 628.

In particular, upon selection of the first “view my jewelry” option 610, the webpage 602 is replaced with for becomes modified so as to constitute) a webpage 630 that allows the customer to view information regarding each of the jewelry items that the customer has purchased through the program, that is, each of the jewelry items that the customer has purchased for which there exists an issued certificate. The webpage 630 continues to list all of the options of the first and second sets of option 606, 608, with the exception of the view my jewelry option. As further shown in FIG. 32, the webpage 630 includes a scrollable bar area 632 along its left margin and a scrolling button 634 that allows the customer to scroll through the items shown in the area 632. In particular, the area 632 shows one or more thumbnail images 636 of the one or more jewelry items that have been purchased by the customer, along with corresponding certificate numbers 638 regarding those jewelry items.

If the customer selects one of the certificate numbers 638, then an image appears of the certificate corresponding to that certificate number. If the customer selects the thumbnail image 636 (or merely places a cursor over the image) then detailed information regarding that jewelry item is provided within a central region 640 of the webpage 630. In the example shown, detailed information is provided within the central region 640 concerning a pair of ladies earrings that were purchased by the customer. As shown, the detailed information not only includes the certificate number pertaining to the purchased jewelry item and a larger image 642 of that jewelry item, but also provides detailed information regarding the purchasing of that jewelry item (e.g., the issue date of the certificate concerning that jewelry item), the value of the jewelry item (e.g., its replacement value), the category or type of jewelry item, the characteristics of the jewelry item (e.g., quantity, cut, color, clarity, carats, type of metal, etc).

Further as shown, the detailed information can also include information regarding other possibly-relevant items. For example, a hyperlink can be provided linking the presently-shown item to another item that is owned by the same customer or could be purchased by the customer (in the example shown, the user is directed to a 7 inch bracelet). Also, the detailed information can include information regarding when the jewelry item was serviced or maintained, information when maintenance should again be performed, information regarding whether an appraisal was performed, information regarding when an appraisal should again be performed, and possibly a variety of other types of information. In addition to displaying this information within the central region 640, the customer is also presented with send and delete buttons 644 and 646, respectively, which allow the customer to send (e.g., email) the information or delete the information, respectively.

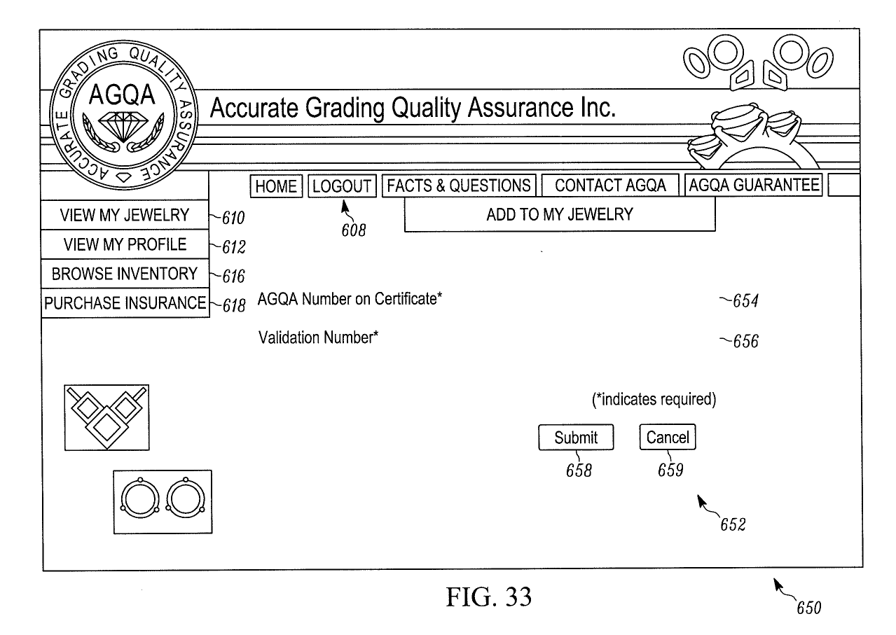

Turning to FIG. 33, upon the selection of the third “add to my jewelry” option 614 (either from the webpage 602 of FIG. 31 or the webpage 630 of FIG. 32) a webpage 650 is presented having a central region 652 with first and second fields 654 and 656 into which the customer is able to enter a certificate number and a validation number, respectively. Once the certificate number and validation number are entered, the customer can submit the information by pressing a submit button 658 or, alternatively, can cancel transaction by pressing a cancel button 659. In this manner, the webpage 650 allows a customer himself or herself to add a newly-purchased jewelry item to the listing of jewelry items associated with that customer, without the assistance of a retailer or any other party. Confirming a purchase of new jewelry item in this manner would be particularly advantageous for a customer who is not able to have a retailer enter such information, for example, because the retailer's sales clerk was busy with other customers at a time that the customer was in the store waiting for assistance in entering the information into the system (e.g., in accordance with the procedure outlined with reference to FIG. 18).

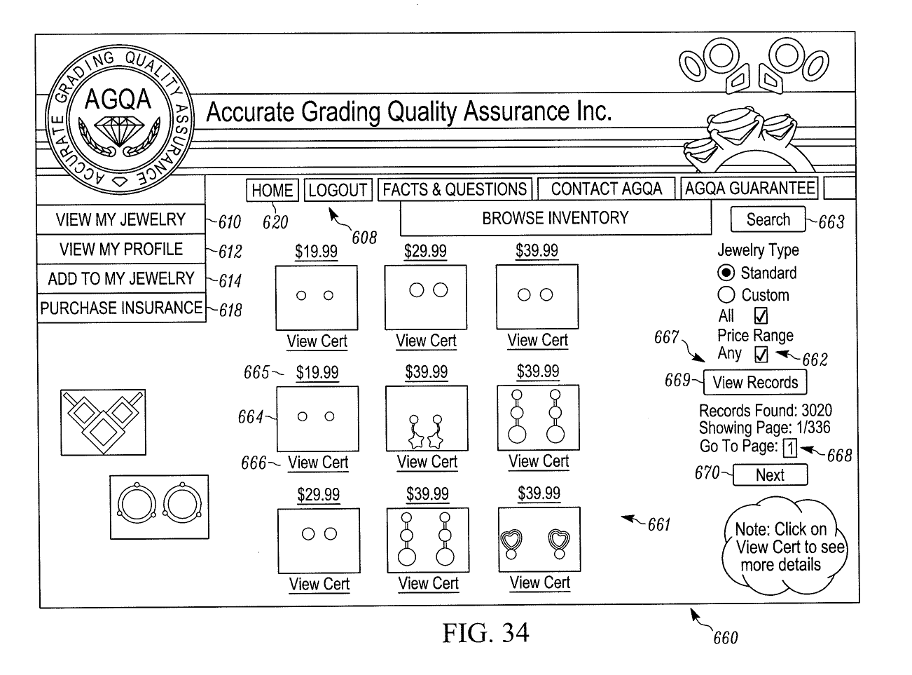

Turning to FIG. 34, upon selection of the fourth “browse inventory” option 616 by a customer (the selection can be made from any of the webpages discussed with reference to FIGS. 31-33), the customer is able to search for and view information concerning jewelry items that have not yet been sold but for which certificates have already been created. The jewelry items can be located at a variety of locations, e.g., at any of a variety of retailers or wholesalers who are involved in the program sponsored by the secondary company. In the embodiment shown, a customer can specify a variety of search criteria to allow the customer to identify jewelry items that are of particular interest, including criteria relating to jewelry type (e.g., whether the jewelry is standard or customized), other characteristics of the jewelry, and price ranges for the jewelry items. These search criteria can be specified by way of one or more search options 662, which in the embodiment shown are located in the upper right hand corner of the central region 661. The search can be commenced upon the pressing of a search button 663.

Once search results have been obtained, the search results are displayed within a central area 661 in a tabular/listing or arrayed format. In the embodiment shown, up to nine records can be shown at any given time. Each record 664 that is shown includes a thumbnail image 664 of the jewelry item, a price 665 of the jewelry item and a button 666 that, if pressed, allows the customer to view an image of the certificate associated with that jewelry item. Further, by selecting or “clicking on” the thumbnail image 664 of a particular item, additional information also can be provided. Additionally, by pressing on the image 664, the user is given an opportunity (e.g., another selection button) to purchase the item or add it to a shopping cart. If this is performed, then the user is provided with a form to complete regarding the purchase (e.g., requesting credit card information and confirmation that the purchase should be made), resulting in the user's purchase of the indicated item(s).

The particular records that are shown can be selected by the customer through the use of view records options 667, which are located below the search options 662. As shown, the view records options 667 indicate the total number of records that were found due to the search, and indicate which page of the pages of records that were identified is currently being displayed in the central region 661. Further, the view records options 667 includes a field 668 into which the customer can enter a page number of a page of the records that the customer wishes to view. By entering such a page number in the field 668 and then pressing a view records button 669, the customer can bring up the particular page of records that is desired by the customer. Alternatively, the customer can press a next button 670 that causes a next page within the set of pages of records that have been found to be displayed.

Although not shown in detail in the figures, upon selecting the fifth “purchase insurance” option 618, the website also allows the customer to be directed to a webpage in which the customer has an ability to purchase insurance concerning a jewelry item. Typically, the webpage is that of an independent insurance carrier that is capable of providing such insurance, although in certain embodiments, the webpage would be simply another webpage of the present website allowing for the customer to purchase insurance from the secondary company sponsoring the website. The second set of options 608 also allow the customer to obtain various types of information. In particular, upon selection of the option 628, the customer is provided with information regarding the guarantee/warranty or guarantees/warranties provided by the secondary company. Upon pressing of the option 626, the customer is provided with contact information concerning the secondary company sponsoring the website, and upon pressing the option 624, the customer is provided with various other information regarding the program offered by the secondary company. Further, the home option 620 allows the customer to return to the welcome webpage 602 at any time, while the log out option 622 causes the customer to become logged out of the website.

The above-described embodiments are only intended to be exemplary of a variety of embodiments that come within the scope of the invention. For example, the particular arrangements of webpages provided via the website as described above are only exemplary, and a variety of other webpages, with a variety of other options and selection arrangements, are also possible. Further, the capabilities of the website and the overall system can vary depending upon the embodiment. As discussed above, it is envisioned that some embodiments of the present system will automatically or semi-automatically conduct proactive communications with customers and others, for example, by sending email messages to customers reminding them of the need to obtain maintenance service, reappraisals, and extended warranties concerning their jewelry items. Such proactive communications could also include reminders to purchase gifts at different times, such as reminders to purchase a gift for a spouse in relation to an upcoming anniversary or birthday, particularly in embodiments where such important dates are elicited from customers and stored in the system. The specific hardware and software components discussed above also are only exemplary and can vary with the embodiment.

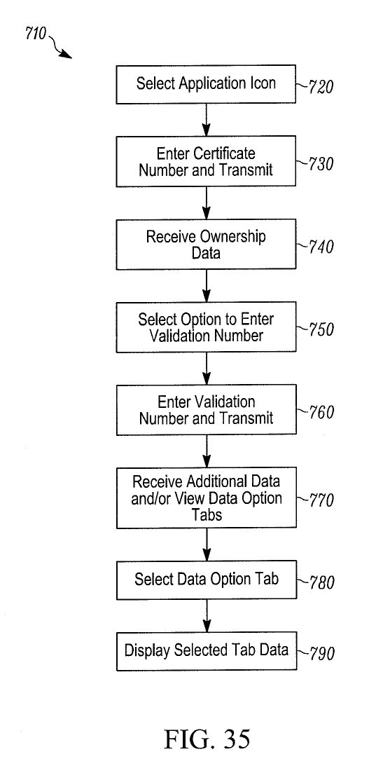

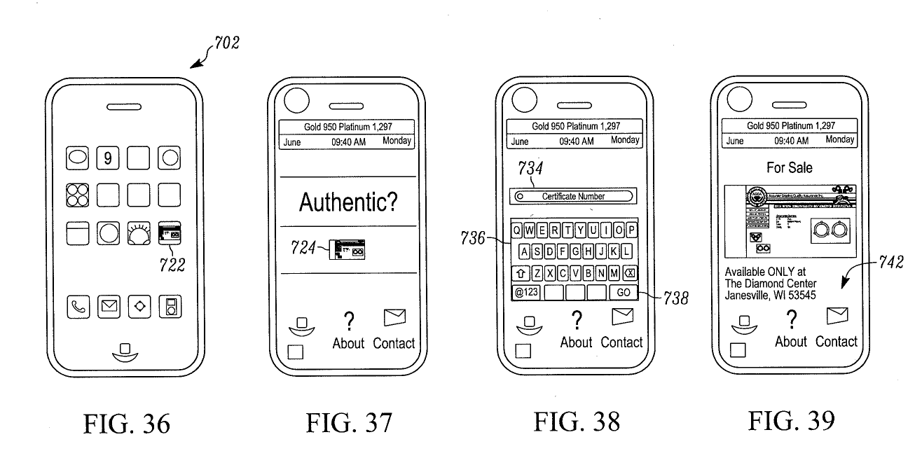

For example, referring now additionally to FIGS. 35-42, in further embodiments the central terminal 80 can be accessed by way of remote terminals such as a mobile device 702 (see FIG. 36 in particular). That is, one or more mobile devices such as the mobile device 702 can be employed by a user to interact with the central terminal 80. Depending upon the embodiment, such mobile devices can constitute one or more of (or a substitute of one or more of) the remote terminals such as the remote terminal 130 of FIG. 2, and/or alternatively can be employed in addition to other remote terminals such as the remote terminal 130. In such embodiments, such mobile devices can more particularly communicate with the central terminal 80 by way of the internet 90 using one or more wireless communication technologies such as conventional cellular telephone communications technologies, wireless local area network (WLAN) and/or BlueTooth technologies.

In at least some such embodiments, and as already discussed above, the central terminal 80 includes a web server by which a web browser program resident at the mobile device 702 is able to download web pages from a website associated with the central terminal. Further, in at least some such embodiments, the mobile device 702 also has one or more resident applications in addition to (or instead of) a browser program that allow for interactions between the mobile device and the central terminal 80, which can be but need not always have a web server. Although the mobile device 702 is shown to be a personal digital assistant (PDA), it should be understood that any of a variety of other types of mobile devices can be employed as well including, for example, cellular telephones, portable (e.g., notebook or laptop) computers, etc. In some alternate embodiments, one or more mobile devices can communicate with the central terminal 80 by way of wireless communication technologies that do not involve the internet.

It will be understood that a mobile device such as the mobile device 702 typically will be capable of accessing any of the same types of data available at the central terminal 80, and otherwise interacting with the central terminal in substantially (and possibly exactly) the same manners as are described above (e.g., in relation to the terminals 10, 110, 130, etc.). For example, the mobile device 702 can be used to access jewelry-related data 150 or other data available at the databases 140 shown in FIG. 2.

FIGS. 35-42 are further provided in order to illustrate additional interactions that can occur between a user, such as a prospective buyer or recent buyer of a jewelry item, and the central terminal 80, by which the user is able to obtain additional verification information from the central terminal. As will be discussed below, these additional interactions in particular facilitate verification of the ownership status of a given jewelry item that is about to be sold (or has recently been sold) by a seller to a prospective buyer. That is, these interactions allow for information to be obtained by the prospective buyer that allow the buyer to confirm that the seller actually owns (or at least otherwise has rights to be selling) the jewelry item of interest. Such information can be particularly desirable where the seller is not an established jeweler, large retailer, original retailer (or wholesaler) or other party that by virtue of its identity and reputation would likely be presumed by a buyer to have legal ownership of the jewelry item, but rather is (for example) a downstream reseller of the jewelry item such as an individual or small store that is not a jewelry store.

More particularly referring to FIG. 35, a flow chart 710 shows exemplary steps of operation of the mobile device 702 as operated by a prospective, purchaser, by which the purchaser is able to obtain ownership verification information for a jewelry-related item from the central terminal 80. In addition, FIGS. 36-42 provide exemplary screen shots of the device 702 as it interacts with the central terminal 80 for this purpose. Although FIGS. 35-42 relate to operations performed by the mobile device 702, it should be understood that similar operations can similarly be performed by other types of terminals such as the computer terminals described above in relation to FIGS. 1-3. Further, in the case of the mobile device 702, it will be understood that the display of the mobile device serves as a touch screen, such that a user is able to select choices displayed as icons or buttons on the mobile device simply by touching those displayed icons or buttons. Nevertheless, it should be understood that, depending upon the mobile device, any of a variety of other input/output schemes can be utilized as well to allow a user to review output data and provide inputs, commands or selections to the mobile device.

As shown in FIG. 35, beginning at a step 720, a user, in this case a prospective purchaser, selects a mobile application icon 722 on the mobile device 702 and elects to proceed with an ownership verification (or authentication) process by pressing a button 724 (as seen in FIGS. 36 and 37). Next, at a step 730, a first input data screen 732 with a data entry field 734 is provided (as seen in FIG. 38) on the mobile device 702, into which the prospective purchaser enters a certificate number. In the present embodiment, the certificate number is entered into the field 734 using a keypad 736 provided on the screen 732, and is submitted upon the prospective purchaser pressing a go button 738 also found on the screen 732. Upon the pressing of the go button 738, the certificate number is transmitted by the mobile device 702 to the central terminal 80 (see FIG. 2). As described earlier certificate number is associated with a certificate that contains data regarding a particular jewelry item that is being sold to the prospective purchaser, and typically will have been provided to the prospective purchaser by the seller of the jewelry item to which the certificate pertains.

in the present embodiment, upon receiving the certificate number from the mobile device 702, the central terminal 80 in particular locates ownership data associated with the certificate number that was entered and transmits the ownership data back to the mobile device, which receives that data at a step 740. Upon receiving the ownership data, the mobile device 702 then displays that ownership data in an ownership data field 742 of a first output data screen 743 (as seen in FIG. 39), such that the ownership data can then be reviewed by the prospective purchaser. In addition to displaying the ownership data, other information can be provided on this screen as well, including an indicator that the item is registered as being for sale. Thus, upon completion of the step 740, the user (prospective purchaser) has verified ownership of the jewelry item that is of interest for purchase.

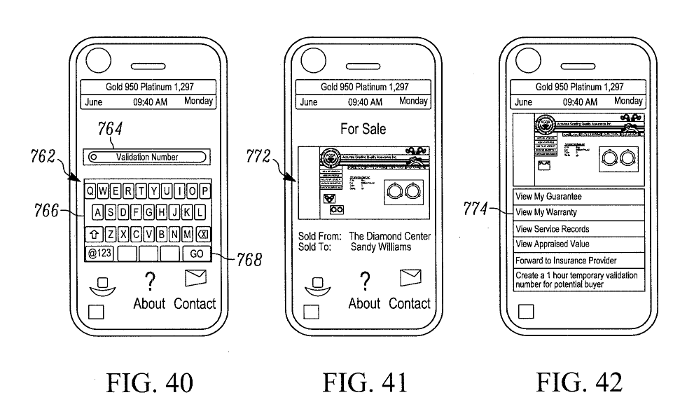

Still referring to FIG. 35, in at least some embodiments the seller can provide the prospective purchaser not only with a certificate number but also with a temporary or current validation number. The validation number, if provided to and used by the prospective purchaser, enables the prospective purchaser to access additional data concerning the jewelry item being purchased including, for example, the item's service records or appraised value. Further referring to the flow chart 710, at a step 750, assuming that the seller has provided the prospective purchaser with such a validation number, the prospective purchaser can select another option available on the mobile device 702 (this can occur upon selection of another appropriate icon as shown in FIG. 36) such that a second input data screen 762 (see FIG. 40) appears on the mobile device. Subsequently, at a step 760, the prospective purchaser enters the validation number into a box 764 provided on the screen 762, using a keypad 766 provided on the screen, and the validation number is then submitted upon the prospective purchaser pressing a send button 768 also provided on the screen.

Upon the pressing of the send button 768, the mobile device 702 then transmits the validation number to the central terminal 80 for verification. Next, at a step 770, if the validation number is verified by the central terminal 80, the central terminal in turn sends back to the mobile device 702 additional data not previously available to the prospective purchaser, such as cumulative purchase and sale information, appraised value, and/or service records. Upon receiving that additional data, a second output data screen 772 (as seen in FIG. 41) is provided by the mobile device 702 on which is displayed some or all of that additional data for review by the prospective purchaser.

In an alternate embodiment, instead of providing the second output data screen 772, the mobile device 702 rather provides a different output data screen that instead (or in addition) displays one or more selectable data option tabs 774 (as shown in FIG. 42). By selecting one or more of the tabs 774, at a step 780, different types of the additional data are then displayed. For example, in at least the present embodiment, at the step 780, the prospective purchaser can select from among any of the “View My Guarantee”, “View My Warranty”, “View Service Records”, or “View Appraisal Value” data tabs 774 so as to cause the mobile device to display, at a step 790, any of guarantee information, warranty information, service records information, or appraisal value information, respectively. Although the flow chart 710 shows additional data being received at the step 770, in at least some alternate embodiments, the additional data is not received by the mobile device 702 from the central terminal 80 until after one of the tabs 774 has been selected at the step 780.

Although the description above concerning FIGS. 35-42 envisions that a prospective purchaser utilizes the mobile device 702 to obtain various data upon entering the certificate and/or validation numbers, other parties can also access this data in the same manner as well. For example, a purchaser can utilize the mobile device 702 to access this information in the same manner even after the jewelry item has been purchased. Also, a seller can access this information as well prior to the sale of a jewelry item. Indeed, additional ones of the data option tabs 774 can provide features intended for use only by the seller, for example, allowing the seller to request a temporary validation number that automatically expires after a period of time (also, either the seller or a purchaser can submit a request that information be forwarded to an insurance provider). The temporary validation number can be subsequently given to a prospective purchaser, thereby allowing the customer unfettered access to data, but only for a limited time.

Further, after a purchaser has bought a jewelry item, the ownership data can be updated by the seller (e.g., at the point of sale) or by the purchaser, again by providing an appropriate selection (e.g., by selecting one of the tabs). A new validation number can at that time also be assigned to the new owner and the previous validation number can be disabled to prevent future access from the seller. Once the seller has reassigned ownership, the purchaser can use the certificate number and new validation number to verify that the item is registered to the purchaser rather than some other party. By virtue of updating this information, the ownership chain can be maintained by the party operating the central terminal 80, and thus future purchasers can again potentially access and make use of this information when the jewelry item is again sold at one or more later times.

Notwithstanding the description provided above, the present invention is intended to encompass numerous other embodiments as well. For example, while the above description pertaining to FIGS. 35-42 largely concerns how ownership information can be made available to prospective purchasers, it is also envisioned that other information can also be provided to prospective purchasers indicating that a particular seller has authority to sell a jewelry item (e.g., that the seller is an authorized distributor or broker for the particular jewelry item). Also for example, while the above embodiments discuss the use of a certificate number and a validation number, these “numbers” can include any of a variety of alphanumeric characters, other symbols and/or codes, and should not be construed to be limited to traditional numbers. Further, it should be understood that the database 140 of FIG. 2 can include all the data 150 that is associated with a particular certificate as well as a variety of additional data such as (but not limited to) the additional data described above that may not necessarily be listed on any certificate. Also, other types of data can also be stored at the central terminal 80, for example, sale status (e.g., pending sale status) information, etc.

Additionally, while the flow chart 710 of FIG. 35 sets forth steps of operation that are performed by the mobile device 702, the present invention is also intended to encompass complementary steps of operation performed by the central terminal 80 that correspond to and allow such steps of operation by the mobile device. For example, the present invention in at least some embodiments also includes a process in which a central terminal such as the central terminal 80 receives certificate number information from a mobile device for other remote terminal) and, in response, searches for and provides back to the mobile device ownership information. Additionally, the present invention in at least some embodiments also includes a process in which a central terminal receives validation number information from a mobile device for other remote terminal) and, in response, searches for and provides back to the mobile device additional data such as that described above (e.g., previous sale information, appraisal information, service records, warranty or guarantee information, etc.).

It is specifically intended that the present invention not be limited to the embodiments and illustrations contained herein, but include modified forms of those embodiments including portions of the embodiments and combinations of elements of different embodiments as come within the scope of the following claims. Additionally, the present invention is intended to be applicable not only to a variety of different types of jewelry items, but also to a variety of other moderate to less-expensive collectible-type items including, for example, coins, antiques, baseball cards, dolls, and other similar collectibles that are available from a wide variety of different retailers.

We claim:

1. A method of verifying ownership of a first jewelry-related item, the method comprising:
receiving a certificate number associated with a first certificate corresponding to the first jewelry-related item at a mobile device capable of internet access;
sending the certificate number from the mobile device for receipt by an internet accessible central terminal that is at least one of operated and controlled by an entity that provides guarantees or warranties in relation to a plurality of certificates that respectively pertain to respective jewelry items, the plurality of certificates including the first certificate;
receiving ownership data pertaining to the first jewelry-related item at the mobile device from the central terminal; and
displaying the ownership data on the mobile device.

2. The method of claim 1, wherein the mobile device is at least one of a cellular phone, a personal digital assistant (PDA), and a portable computer.

3. The method of claim 2, wherein the mobile device includes an application for interfacing with the central terminal via the internet.

4. The method of claim 3, wherein the application includes a browser application capable of processing web page information received from the central terminal.

5. The method of claim 2, wherein the mobile device receives the certificate number from a prospective purchaser who in turn received the certificate number from a seller of the jewelry-related item.

6. The method of claim 1, further comprising:
receiving a validation number corresponding to either the first certificate or the first jewelry-related item at the mobile device;
sending the validation number from the mobile device for receipt by the central terminal; and
receiving additional data at the mobile device from the central terminal pertaining to the jewelry-related item; and
displaying the additional data on the mobile device.

7. The method of claim 6, wherein the additional data includes at least one of purchase or sale information pertaining to at least one previous sale of the first jewelry item, an appraisal value of the first jewelry item, warranty information pertaining to the first jewelry item, and guarantee information pertaining to the first jewelry item.

8. The method of claim 6, wherein the verification number is a temporary verification number.

9. The method of claim 6, further comprising sending additional ownership data for receipt by the central terminal, the additional ownership data being reflective of a recent change in ownership of the first jewelry-item.

10. The method of claim 9, further comprising receiving a new validation number for future use a recent purchaser.

11. A method of facilitating verification of ownership of a first jewelry-related item, the method comprising:
receiving at a central terminal, from a mobile device via an interne-type communications medium, a certificate number associated with a first certificate corresponding to the first jewelry-related item, wherein the central terminal is at least one of operated and controlled by an entity that provides guarantees or warranties in relation to a plurality of certificates that respectively pertain to respective jewelry items, the plurality of certificates including the first certificate;
searching a database associated with the central terminal for ownership data pertaining to the first jewelry-related item; and
sending the ownership data from the central terminal for receipt by the mobile device.

12. The method of claim 11, further comprising:
receiving at the central terminal a validation number;
searching for additional data including at least one of purchase or sale information pertaining to at least one previous sale of the first jewelry item, an appraisal value of the first jewelry item, warranty information pertaining to the first jewelry item, and guarantee information pertaining to the first jewelry item; and
sending the additional data from the central terminal for receipt by the mobile device.

13. The method of claim 11, further comprising:
receiving a request for issuance of a validation number; and
determining and sending the validation number for receipt by a prospective seller, wherein the validation number is only valid for a limited period of time.

14. The method of claim 11, wherein the ownership data either confirms that a prospective seller owns the first jewelry-related item or confirms that the prospective seller is authorized to sell the first jewelry-related item even though the first jewelry-related item is owned by another party.

15. A system for verifying ownership of a first jewelry-related item, the system comprising:
a central terminal that includes a database, wherein the central terminal is at least one of operated and controlled by an entity that provides guarantees or warranties in relation to a plurality of certificates that respectively pertain to respective jewelry-related items, the plurality of certificates including a first certificate pertaining to the first jewelry-related item,
wherein the database stores not only certificate data regarding the plurality of certificates but also additional data pertaining to the jewelry-related items, the additional data including ownership data indicative of a current owner of the first jewelry-related item,
wherein the central terminal is capable of being accessed by way of a remote terminal communicating with the central terminal via an internet-type communications medium, and
wherein the central terminal sends the ownership data onto the internet-type communications medium for receipt by the remote terminal in response to receiving a certificate number corresponding to the first certificate.

16. The system of claim 15, wherein the central terminal provides a website that includes at least one web page that is accessible by the remote terminal, the remote terminal being at least one of a desktop computer and a mobile device that includes an application allowing for communications with the central terminal.

17. The system of claim 16, wherein the at least one web page includes a first web page that when communicated to the remote terminal allows the remote terminal to display either a first input data screen into which can be entered a certificate number, or a first output data screen for displaying at least some of the additional data.

18. The system of claim 15, wherein the additional data includes both a first level of data that includes the ownership data including at least one of an identity of an owner or a seller of the first jewelry-related item, and a second level of data that includes at least one of cumulative purchase and sale information, warranty information, guarantee information, appraised value information and service records information.

19. The system of claim 15, wherein the central terminal sends additional portions of the additional data onto the internet-type communications medium for receipt by the remote terminal in response to receiving a validation number and verifying that the validation number corresponds to the first certificate.

20. The system of claim 15, wherein the central terminal includes means for generating a temporary validation number, the means including at least one computer-type device, the temporary validation number being generated in response to a request received at the central terminal from a prospective seller.
